(19) United States
(12) Patent Application Publication
(10) Pub. No.: US 2011/0246078 A1
(43) Pub. Date: Oct. 6, 2011

(54) MITOCHONDRIA KATP ION CHANNEL AS A DRUG TARGET FOR PREVENTING LIVER DISEASES AND METHODS TO SCREEN MITOCHONDRIA KATP MODULATORS

(76) Inventors: Ye Fang, Painted Post, NY (US); Joydeep Lahiri, Painted Post, NY (US); Haiyan Sun, Baltimore, MD (US); Ying Wei, Painted Post, NY (US)

(21) Appl. No.: 13/069,987

(22) Filed: Mar. 23, 2011

Related U.S. Application Data
(60) Provisional application No. 61/319,061, filed on Mar. 30, 2010.

(51) Int. Cl. G06F 19/00

(52) U.S. Cl. 702/19

(57) ABSTRACT

Disclosed are compositions and methods related to modulation of K_{ATP} channels and methods of treating liver disorders by modulating K_{ATP} and mito-K_{ATP} channels.

### CLAIMING BENEFIT OF PRIOR FILED U.S. APPLICATION

This application claims the benefit of priority to U.S. Provisional Application No. 61/319,061, filed on Mar. 30, 2010, which is incorporated by reference here.

### BACKGROUND

Adenosine triphosphate sensitive potassium channels (K_{ATP} channels) serve as molecular sensors linking the cellular metabolic level to cell membrane excitability. To date, mechanisms for quickly and efficiently assessing molecules for their ability to modulate K_{ATP} channels have been limited to cumbersome electrical type assays. Provided herein are methods, compositions, and machines for performing K_{ATP} channel assays in cells, such as liver cells, and specifically mitochondrial K_{ATP} channels can be assayed. Also disclosed are methods of treating liver disorders by modulating K_{ATP} channels in liver cells.

### SUMMARY

Disclosed herein are methods of using mitochondria ATP-sensitive potassium ion channel (mito-K_{ATP}) as a drug target. In some embodiments, the methods can identify compounds that can prevent or treat liver diseases. In some embodiments, the compounds are mito-K_{ATP} channel modulators. Also disclosed herein are methods of using label-free biosensor cellular assays to screen for mito-K_{ATP} channel modulators in liver cells.

### BRIEF DESCRIPTION OF THE DRAWINGS

FIG. 1 shows the expression of endogenous K_{ATP} channels in a liver cell line HepG2C3A.

FIG. 2 shows that the endogenous K_{ATP} ion channel is presented in mitochondria in HepG2C3A cells, as evidenced by Western blotting of its Kir6.2 subunit.

FIG. 3 shows the K_{ATP} opener pinacidil-induced DMR signals in HepG2C3A cells, as recorded in real time according to one embodiment of the present invention. (A) shows the real time kinetic DMR signals of HepG2C3A in response to stimulation with pinacidil at different doses. (B) shows the amplitudes of the pinacidil DMR signals at 30 min after stimulation, as well as the kinetics (t_{1/2}) of the pinacidil DMR signals, as a function of pinacidil doses.

FIG. 4 shows the impact of SURs knockdown by siRNA on the pinacidil-induced DMR signals in hepG2C3A cells. (A) shows the real time kinetics of the pinacidil DMR signal with and without RNAi knockdown of SUR2 or SUR1. (B) shows the amplitudes of cell responses to pinacidil (30 min after stimulation) as a function of different RNAi knockdown pretreatments. The negative control (i.e., cellular response to the vehicle buffer) is also included.

FIG. 5 shows the impact of Kir6.x knockdown by siRNA on the pinacidil-induced DMR signals in hepG2C3A cells. (A) shows the real time kinetics of the pinacidil DMR signal with and without RNAi knockdown of Kir6.1 or Kir6.2. (B) shows the amplitudes of cell responses to pinacidil (30 min after stimulation) as a function of different RNAi knockdown pretreatments. The negative control (i.e., cellular response to the vehicle buffer) is also included.

FIG. 6 shows the pharmacological characterization of mito-K_{ATP} channels in HepG2C3A cells. (A) shows the dose-dependent inhibition of the pinacidil DMR signal by the known K_{ATP} blocker tolazamide. (B) shows the dose dependent modulation of the pinacidil DMR signal by a panel of known K_{ATP} blockers, as plotted as the amplitudes of the pinacidil DMR signals as a function of their doses. (C) shows the impacts of different blockers, each at 32 on the pinacidil DMR signals. In all experiments, the pinacidil concentration was 40 μM.

FIG. 7 shows that the Mito-K_{ATP} signaling is linked to Rho kinase activity. ROCK inhibitor Y-27632 dose-dependently attenuated the pinacidil DMR signals in HepG2C3A cells. (A) shows the real time kinetic pinacidil DMR signals in the presence of Y-27632 at different doses. (B) shows the amplitudes of the pinacidil DMR signal as a function of Y27632 doses. In all experiments, the pinacidil concentration was 40 μM.

FIG. 8 shows that the Mito-K_{ATP} signaling is linked to Rho kinase activity. RNAi knockdown of either ROCK1 or ROCK2 significantly attenuated the pinacidil DMR signals: (A) shows the real time pinacidil DMR signals, and (B) shows the amplitudes of the pinacidil DMR as a function of different RNAi knockdown. Also RNAi knockdown significantly reduced the corresponding proteins in HepG2C3A cells: (C) shows the ROCK1 knockdown, and (D) shows the ROCK2 knockdown. In all experiments, the pinacidil concentration was 40 μM.

FIG. 9 shows that the Mito-K_{ATP} signaling is linked to actin remodeling. The does-dependent inhibition of the pinacidil DMR signals by two well-known actin disruption agents, (A) shows cytochalasin B, and (B) shows latrunculin A. In all experiments, the pinacidil concentration was 40 μM.

FIG. 10 shows that the Mito-K_{ATP} signaling is linked to JAK kinase activity. The JAK inhibitor AG490 dose-dependently inhibited the pinacidil DMR signals in HepG2C3A cells: (A) shows the real time kinetics; (B) shows the amplitudes of the pinacidil DMR as a function of AG490 doses. In all experiments, the pinacidil concentration was 40 μM.

FIG. 11 shows that the mito-K_{ATP} channel signaling is linked to JAK activity. RNAi knockdown of either JAK2 or JAK3, but not JAK1, significantly attenuated the pinacidil DMR signals: (A) shows the real time pinacidil DMR signals, and (B) shows the amplitudes of the pinacidil DMR as a function of different RNAi knockdown.

FIG. 12 shows that the mito-K_{ATP} channel modulation suppressed the rifampin caused induction of CYP3A4 activity in primary liver cells. (A) shows the impact of pinacidil on the CYP3A4 activity. (B) shows the impact of pinacidil on the rifampin induction of CYP3A4 activity. (C) shows the impact of glipizide on the CYP3A4 activity. (D) shows the impact of glipizide on the rifampin induction of CYP3A4 activity. (E) shows the impact of pinacidil on the CYP1A2 activity. (F) shows the impact of glipizide on the CYP1A2 activity. The primary liver cells were pre-incubated with compounds at specific doses for 3 days before CYP the enzymatic activity measurements.

### DETAILED DESCRIPTION

### A. Materials, Compositions, and Assays

1. Ion Channels

Ion channels are integral membrane proteins that control the movement of ions across the cell membrane. In humans, about 400 genes encode for proteins that can assemble to form more than several thousand different ion channel subtypes as these are usually heteromultimeric complexes with pore-forming and accessory subunits. These subtypes can be classified according to their ion selectivity, sequence homology, quaternary structure or gating mechanism. Ion channels control the electrical properties of cells by gating in response to a wide array of stimuli. To date, ion channels have been identified that are sensitive to changes in the concentration of ligands such as small molecules and ions, changes in membrane potential, temperature fluctuations, alterations in membrane tension, and most recently, exposure to visible light.

Ion channel proteins can be gated by intra- or extracellular ligands or ions, voltage, temperature or stretch. Ion flux through channels in the cell membrane is determined by three factors: the number of functional channels, the driving force that exists for ions down their electrochemical gradient and the proportion of channels in the open, ion-conducting state. This open probability can be modulated by a large variety of signaling molecules, including G-proteins, lipids, kinases as well as other signaling molecules.

Ion channels can play a crucial role in molecular pathways that lead to human disease states which is reflected by the increasing number of known links between diseases and congenital ion channel dysfunctions (so called channelopathies). Furthermore, ion channels are among the five major drug target families, with G protein coupled receptors, kinases, transporters and enzymes. L-type Ca²⁺ channel blockers for treating hypertension, cell membrane K_{ATP} channel openers for treating diabetes, GABAA receptor modulators for treating anxiety and use-dependent Na⁺ channel blockers given to patients with epilepsy and arrhythmia, are examples of drugs that have blockbuster sales figures. Thus, ion channels are very attractive drug targets.

However, most marketed ion channel drugs were found by serendipity, and ion channel drug discovery using multi-million compound libraries has been hampered by the lack of functional assays amenable to high throughput technology.

2. The liver and liver diseases

The liver is the primary site of metabolism of the vast number and types of chemicals that humans are exposed to on a daily basis. The most important class of metabolic enzymes in the liver is the cytochrome P450s, which are actively involved in the clearance of drugs and other chemicals. The P450s start the process of breaking down chemicals so they can be excreted, but during metabolism, some active metabolites, which have the desired pharmacologic effects, can be created. However, the converse is also true; metabolism can produce toxic metabolites, such as in the breakdown of the common analgesic acetaminophen.

The liver is the primary site of detoxification of many toxic substances from the blood, as well as the synthesis and secretion of many compounds. Hepatocytes, the most abundant cells that make up 70-80% of the cytoplasmic mass of the liver, carry out most of the metabolic and biosynthetic processes in liver. Thus, in vitro cultured hepatocytes have become popular for drug metabolism and toxicity studies.

Hepatitis (plural hepatitides) implies injury to the liver characterized by the presence of inflammatory cells in the tissue of the organ. The condition can be self-limiting, healing on its own, or can progress to scarring of the liver. Hepatitis is considered acute when it lasts less than six months and chronic when it persists longer. Hepatitis can be caused by hepatitis viruses which cause the most cases of liver damage worldwide. Hepatitis can also be due to toxins (notably alcohol), other infections or from autoimmune processes.

There are many types of hepatitis, including hepatitis A, B, C, D, E, F and G, and ischemic hepatitis. Hepatitis can be induced by viruses (e.g., hepatitis A-E are mostly caused by viral infection). Hepatitis can also be due to toxins, chemicals, and drug molecules (e.g., alcohol, toxins, paracetamol, amoxycillin, antituberculosis medicines, minocycline). Hepatitis can also be due to circulatory insufficiency (i.e., ischemic hepatitis), auto immune conditions, metabolic diseases, or heredity such as Wilson's disease.

Acute hepatitis can be caused by an infection of hepatitis A through E (more than 95% of viral cause), herpes simplex, cytomegalovirus, Epstein-Barr, yellow fever virus, and adenoviruses. Acute hepatitis can be also caused by non viral infection such as toxoplasma, Leptospira, Q fever, and Rocky Mountain spotted fever, as well as by chemicals and toxins such as alcohol, toxins, and drugs (e.g., paracetamol, amoxycillin, antituberculosis medicines, minocycline and many others). Chronic hepatitis is typically caused by viral hepatitis (i.e., Hepatitis B with or without hepatitis D, hepatitis C), autoimmune, alcohol, certain drugs (e.g., methyldopa, nitrofurantoin, isoniazid, ketoconazole), and can also be due to heredity such as Wilson's disease, and alpha 1-antitrypsin deficiency.

The human body identifies almost all drugs as foreign substances and subjects them to various chemical processes (i.e. metabolism) to make them suitable for elimination. This involves chemical transformations to (a) reduce fat solubility and (b) to change biological activity. Although almost all tissue in the body has some ability to metabolize chemicals, smooth endoplasmic reticulum in the liver is the principal “metabolic clearing house” for both endogenous chemicals (e.g., cholesterol, steroid hormones, fatty acids, and proteins), and exogenous substances (e.g. drugs or other non-native chemicals).

The central role played by the liver in the clearance and transformation of chemicals also makes it susceptible to drug induced injuries, termed as hepatotoxicity. Certain medicinal agents, when taken in overdoses and sometime even when introduced within therapeutic ranges, can injure the liver. Other chemical agents such as those used in laboratories and industries, natural chemicals (e.g. microcystins) and herbal remedies can also induce hepatotoxicity.

More than 900 drugs have been implicated in causing liver injury and it is the most common reason for a drug to be withdrawn from the market. Chemicals often cause subclinical injury to the liver which only manifests as abnormal liver enzyme tests. Drug induced liver injury is responsible for 5% of all hospital admissions and 50% of all acute liver failures. Several mechanisms are responsible for either inducing hepatic injury or worsening the damage process. Many chemicals can damage the mitochondria, an intracellular organelle that produces energy. Its dysfunction releases excessive amount of oxidants which in turn can injure hepatic cells. Activation of some enzymes in the cytochrome P-450 system such as CYP2E1 can also lead to oxidative stress. Injury to hepatocyte and bile duct cells lead to accumulation of bile acid inside liver. This can promote further liver damage. Non-parenchymal cells such as Kupffer cells, fat storing stellate cells and leukocytes (i.e. neutrophil and monocyte) can also have role in the mechanism.

Drug metabolism is usually divided into two phases: phase 1 and phase 2. Phase 1 reaction is thought to prepare a drug for phase 2. However, many compounds can be metabolized by phase 2 directly. Phase 1 reaction involves oxidation, reduction, hydrolysis, hydration and many other rare chemical reactions. These processes tend to increase water solubility of the drug and can generate metabolites which are more chemically active and potentially toxic. Most of phase 2 reactions take place in cytosol and involves conjugation with endogenous compounds via transferase enzymes. Chemically active phase 1 products are rendered relatively inert and suitable for elimination by this step.

A group of enzymes located in the endoplasmic reticulum, known as cytochrome P-450, is the most important family of metabolizing enzyme in liver. Cytochrome P-450 is the terminal oxidase component of an electron transport chain. It is not a single enzyme, rather consists of a family of closely related 50 isoforms, six of them metabolize 90% of drugs. There is a tremendous diversity of individual P-450 gene products and this heterogeneity allows the liver to perform oxidation on a vast array of chemicals (including almost all drugs) in phase 1. Three important characteristics of the P450 system, genetic diversity, change in enzyme activity and competitive inhibition, have roles in drug induced toxicity. Many substances can influence P-450 enzyme mechanism. Drugs interact with the enzyme family in several ways. Drugs that modify Cytochrome P-450 enzyme are referred to as either inhibitors or inducers. CYP inhibitors block the metabolic activity of one or several P-450 enzymes. This effect usually occurs immediately. On the other hand inducers increase P-450 activity by increasing its synthesis. Depending on inducing drug's half life, there is usually a delay before enzyme activity increases.

Adverse drug reactions are classified as type A (intrinsic or pharmacological) or type B (idiosyncratic). Type A drug reaction accounts for 80% of all toxicities. Drugs or toxins that have a pharmacological (type A) hepatotoxicity are those that have predictable dose-response curves (higher concentrations cause more liver damage) and well characterized mechanisms of toxicity such as directly damaging liver tissue or blocking a metabolic process. As in the case of acetaminophen overdose, this type of injury occurs shortly after some threshold for toxicity is reached. Idiosyncratic injury occurs without warning, when agents cause non-predictable hepatotoxicity in susceptible individuals which is not related to dose and has variable latency period. This type of injury does not have a clear dose-response or temporal relationship, and most often do not have predictive models. Idiosyncratic hepatotoxicity has led to the withdrawal of several drugs from market even after rigorous clinical testing as part of the FDA approval process; Troglitazone (Rezulin®) and trovafloxacin (Trovan®) are two prime examples of idiosyncratic hepatotoxins. The development of anticoagulant ximelagatran (Exanta®) was discontinued for concerns of liver damage.

3. ATP-Sensitive Potassium Ion Channels and mito-K_{ATP} Channels

Adenosine triphosphate sensitive potassium channels (K_{ATP} channels) serve as molecular sensors linking the cellular metabolic level to cell membrane excitability. The K_{ATP} channels are activated by interaction with intracellular MgADP and inhibited by high levels of ATP. One K_{ATP} channel protein complex consists of four small pore-forming inward rectifying potassium channel subunits (Kir6.1 or Kir6.2) and four regulatory β subunits called sulfonylurea receptor (SUR1 or SUR2A, 2B) which is a member of the ATP binding cassette (ABC) superfamily K_{ATP} channels express in various tissues with different molecular compositions including cardiac myocytes, pancreatic β cells, smooth muscle cells, and neurons (Seino S. Annu. Rev. Physiol. 1999. 61:337-62). Besides expression on cell plasma membrane, the K_{ATP} channels can also be found in the inner membrane of mitochondria (Inoue I., et al. Nature 1991; 352:244-7) and nuclear envelope (I. Quesada, et al. PNAS 2002; 99: 9544-9549).

i. K_{ATP} Channel Structure, Function and Related Diseases

Similar to other inward rectifying K⁺ channels, each subunit of Kir6.1 and Kir6.2 have two transmembrane segments (M1 and M2) and a pore-forming region with intracellular N-terminus and C-terminus which contains several potential Protein Kinase A (PKA) or Protein Kinase C (PKC) dependent phosphorylation sites (Seino S. Annu. Rev. Physiol. 1999. 61:337-62). Each of the SUR subunit contains three transmembrane domains (TMD 0, 1 and 2) and two intracellular nucleotide binding domains (NBD1 and 2). SUR1 and SUR2 differ in their binding affinity to sulfonylureas and tissue distribution, while the two variants of SUR2 only differ from each other in the last 42 amino acids. Interaction between the Kir and SUR subunits not only determines K_{ATP} channel expression on the cell surface but also regulates the channel activity upon ATP binding and hydrolysis.

In pancreatic 13 cells, the K_{ATP} channels are composed of Kir6.2 and SUR1, they play an important role in regulating insulin secretion. A high glucose level in the blood stream induces an increase of cytosolic ATP concentration in the cells resulting in the closure of K_{ATP} channels, this leads to β cell membrane depolarization and the opening of voltage gated Ca²⁺ channels and subsequent insulin secretion. Sulfonylureas (such as Tolbutamide and Glipizide) can bind to SUR1 with high affinity and inhibit K_{ATP} channel activity thereby stimulating insulin secretion. Loss of function mutations in SUR1 or Kir6.2 that result in insulin over secretion have been found to cause persistent hyperinsulinemic hypoglycemia of infancy (PHHI). Conversely, mutations that lead to continuous opening of K_{ATP} channels can cause transient or permanent neonatal diabetes.

Over the years the molecular compositions of K_{ATP} channels in different tissues were determined by recombinant expression of different combination of Kir6.x and SURx subunits and comparing with the native ATP sensitive potassium currents. The K_{ATP} channels are predominantly composed of Kir6.2 and SUR2A in cardiac myocytes, Kir6.2 and SUR2B in smooth muscle cells and Kir6.1 and SUR2B in vascular smooth muscle cells. In the heart, both sarcolemmal and mitochondria K_{ATP} channels are suggested to have a protecting effect in ischaemic preconditioning (IPC). K_{ATP} channels play a powerful role in the modulation of the contractility of smooth muscles in bladder, colon and airways. K_{ATP} channels also contribute to vasodilation through the regulation of cyclic AMP dependent PKA signaling pathway or cyclic GMP dependent PKG pathway initiated by vasodilators.

ii. K_{ATP} Channel Openers, Blockers and their Therapeutic Potential

Besides modulation by intracellular ATP/MgADP concentrations, K_{ATP} channels can also be activated by a group of structure diverse compounds called potassium channel openers (KCOs) and blocked compounds such as sulfonylureas and other non-sulfonylurea chemicals (Babenko, A. P. et al. J. Biol. Chem. 2000; 275:717-720). The channel response to different KCOs depends on the molecular composition of the K_{ATP} channels. Diazoxide effectively activate Kir6.2/SUR1 channels but have little effect on Kir6.2/SUR2A channels; while pinacidil, cromakalim, and nicorandil preferentially activate Kir6.2/SUR2 channels. Radioactive binding assays and studies using chimera channels have suggested that KCOs binds to the SUR subunit; in particular, diazoxide binds to the TMD1 and pinacidil or its analogs binds to TMD2; their effects on the K_{ATP} channels are regulated by nucleotides interaction with the NBDs. Sulfonylurea drugs have been used to treat type II diabetes, because they bind to the SUR1 subunit and close the K_{ATP} channel and lead to insulin secretion. These drugs also show similar inhibition on SUR2 based K_{ATP} channels. In addition, there are also non-sulfonylurea blockers, such as U-37883A, which has been reported to selectively inhibit Kir6.1 containing K_{ATP} channels.

Both K_{ATP} channel openers and blockers have therapeutic potential. For example, sulfonylurea drugs have been used for treatment of type II diabetes. In addition, selective K_{ATP} channel blockers can be used for preventing arrhythmias by reducing the action potential duration. K_{ATP} channel openers have been used in treatment of hypertension, hyperinsulinism, coronary artery diseases.

iii. K_{ATP} Channels in Liver Cells

Most studies about K_{ATP} channels have been carried out in pancreatic β cells or cardiac myocytes. Malhi et al. reported the expression of K_{ATP} channels and their effect on cell proliferation in rat hepatocytes and in human liver cancer cell lines (Malhi, H. et al. J. Biol. Chem. 2000, 275: 26050-26057). However, other studies indicate that the human liver cancer cell line HepG2 has little K_{ATP} channel current on the cell surface but that the K_{ATP} channel expression can be induced by transfection of insulin and glucose transporter GLUT2 (Liu, G. J. et al. FASEB J. 2003; 17: 1682-1684).

Nerveless, mitochondria K_{ATP} channels were first reported in 1991 by single channel recording using mitoplasts isolated from rat liver mitochondria (Inoue I, et al. Nature 1991, 352: 244-247). Because of technical difficulty and the complexity of mitochondria, the molecular composition of mitochondria K_{ATP} channels is still not clear (Rodrigo, G. C. and Standen, N. B. Current Pharmaceutical Design, 2005, 11: 1915-1940). It is proposed that mitochondria K_{ATP} channels play a protecting role in IPC in cardiac tissues and prevents cell apoptosis through several possible mechanisms including modulation of reactive oxygen species (ROS) generation, preserving mitochondrial matrix volume, and regulating the mitochondrial Ca²⁺ levels (Ardehali, H. J. Bioenergetics and Biomembranes, 2005, 37: 171-177).

4. Screening for Mitochondria ATP-Sensitive Potassium Ion Channels Using Label-Free Assays

Ion channels still remain a singularly under-exploited class of targets. One limiting factor is the lack of physiologically relevant screening tools. Patch clamping, including conventional and automated patch clamping have low to medium throughput, and involve the use of artificial systems (i.e., engineered cells, and/or artificial assay environment). Most importantly, these assays are single cell assays. However, the cellular response is highly heterogeneous at the single cell level. Equally important is that these assays are invasive—the required tight sealing can perturb the cellular structure of ion channel complexes. In addition to being invasive and the use of artificial systems (i.e., engineered cells and/or dye labeled molecules), ion flux/fluorescence assays generally lead to poor hit quality—high false positives and negatives, due to the requirement of pre-loading dyes or ions which can alter cellular backgrounds. To overcome these drawbacks, the methods disclosed herein screen modulators for endogenous ion channels in native cells using label-free cellular assays. In some embodiments, the disclosed methods use label-free cellular assays to screen modulators for endogenous mito-K_{ATP} ion channels. In some embodiments, the screening is performed in non-conventional cell lines. In some embodiments, the functional roles of the mito-K_{ATP} channels are unknown, but whose activation can be robustly detected by the biosensor cellular assays. The label-free biosensor, particularly optical biosensors including SPR and RWG, are non-invasive, and enable real time detection of ion channel ligand-induced dynamic redistribution of cellular matters within the sensing zone mediated through ion channels. The resultant DMR signal is an integrated cellular response, and follows the entire evolution of ion channel activity. The real time kinetics enables classification of mode of actions of modulators acting on ion channels and their regulatory proteins. Additional benefits of the biosensor ion channel cellular assays can include, but not limited to, that the biosensor ion channel assays can offer novel insights for ion channel modulators that link ion channel activity to cell physiology.

5. Endogenous mito-K_{ATP} as a Therapeutic Target for Preventing or Treating Liver Diseases

The biological, physiological and pathophysiological roles of endogenous mito-K_{ATP} channels in liver cells or liver tissues are unknown. However, there is some evidence indicating that K_{ATP} channels are endogenously expressed in a transformed hepatocyte tumor cell line (HepG2). The disclosed methods can also provide evidence showing that the expression of mito-K_{ATP} channels in transformed in primary liver cells, the cell biology and physiology downstream the activation of endogenous mito-K_{ATP} channels, and the roles of mito-K_{ATP} channel activation in drug metabolism in primary liver cells. The disclosed methods can also identify downstream mito-K_{ATP} activation targets (e.g., JAK and Rho kinases) as potential therapeutic targets for treating liver diseases.

i. Rho Kinases

Rho kinase, also referred to as ROCK, is the major effecter of RhoA. ROCK is a serine/threonine protein kinase of ˜160 kDa which corresponds to gene products, ROCK I and ROCK II (rho-associated coiled-coil containing kinase-1 and -2, also known as Rokb/p160ROCK and Roka, respectively). The two kinases have 64% overall identity in humans with 89% identity in the catalytic kinase domain. Both kinases contain a coiled-coil region and a pleckstrin homology (PH) domain split by a C1 conserved region. The two ROCKs have spatially differential expressions. Rho kinase is autoregulated by its COOH-terminal domain, which folds back onto the active site to inhibit its kinase activity. Only the active GTP bound form of RhoA binds to ROCK and blocks the inactivation of the protein. As long as the active form of Rho is bound to ROCK, the kinase remains active. Rho kinase can also be activated by arachidonic acid and sphingosylphosphorylcholine. The cleavage of the inhibitory COOH-terminus by caspases can result in an increase in ROCK activity during apoptosis.

The serine/threonine kinases ROCK1 and ROCK2 are direct targets of activated Rho GTPases, and aberrant rho/ROCK signaling has been implicated in a number of human diseases. ROCK1 and ROCK2 are closely related members of the AGC subfamily of enzymes that are activated downstream of activated Rho in response to a number of extracellular stimuli, including growth factors, integrin activation, and cellular stress. ROCK activation leads to a concerted series of events that promote force generation and morphological changes. These events contribute directly to a number of actin-myosin-mediated processes, such as cell motility, adhesion, smooth muscle contraction, neurite retraction, and phagocytosis. In addition, ROCK kinases play roles in proliferation, differentiation, apoptosis, and oncogenic transformation, although these responses can be cell type-dependent.

The activation of ROCK results in the subsequent phosphorylation of a number of different downstream targets. The most well known target of Rho kinase is myosin light chain (MLC). Myosin phosphatase is also phosphorylated by Rho kinase and this interaction causes an increase in phosphorylated MLC. In addition, ROCK phosphorylates LIM kinase-1 and kinase-2 (LIMK1 and LIMK2) at conserved threonines in their activation loops, increasing LIMK activity, and the subsequent phosphorylation of cofilin proteins, which blocks their F actin-severing activity. Many other proteins involved in actin cytoskeleton rearrangement are phosphorylated by ROCK.

The ROCK enzymes play key roles in multiple cellular processes, including cell morphology, stress fiber formation and function, cell adhesion, cell migration and invasion, epithelial-mesenchymal transition, transformation, phagocytosis, apoptosis, neurite retraction, cytokinesis, and cellular differentiation. As such, ROCK kinases represent potential targets for the development of inhibitors to treat a variety of disorders, including cancer, hypertension, vasospasm, asthma, preterm labor, erectile dysfunction, glaucoma, atherosclerosis, myocardial hypertrophy, and neurological diseases.

Asthma is a chronic inflammatory airways disease characterized by early and late asthmatic reactions that are associated with infiltration and activation of inflammatory cells in the airways and airway hyperresponsiveness to a variety of stimuli, including neurotransmitters and inflammatory mediators. In asthma, inflammatory mediators that are released in the airways by recruited inflammatory cells and by resident structural cells result in airway hyperresponsiveness caused by increased bronchoconstriction. In addition, chronic inflammation appears to drive remodeling of the airways that contributes to the development of fixed airway obstruction and airway hyperresponsiveness in chronic asthma. Airway remodeling includes several key features such as excessive deposition of extracellular matrix proteins in the airway wall (fibrosis) and increased abundance of contractile airway smooth muscle encircling the airways. Airway hyperresponsiveness could be explained, in part, by increased contraction of airway smooth muscle, caused either by an intrinsic functional change in the muscle or by alterations in the neurogenic and non-neurogenic control of muscle function. In addition, development of airway hyperresponsiveness is underpinned by physical changes in the airways, such as damage of the epithelial layer, mucosal swelling, goblet cell hyperplasia and remodeling of the airway wall. Airway remodeling is typically characterized by thickening of the lamina reticularis, augmented subepithelial extracellular matrix deposition (fibrosis), and increased abundance of contractile airway smooth muscle encircling the airways. Current asthma therapy fails to inhibit these features satisfactorily. Currently, treatment of acute and chronic features of allergic asthma is achieved primarily by β2-adrenoceptor agonists and corticosteroids. Acute bronchospasm, resulting from excessive airway smooth muscle contraction, can be satisfactorily reversed in most patients by inhaled β2-adrenoceptor agonists as they cause airway smooth muscle relaxation. Unfortunately, however, patients can develop tolerance to β2-adrenoceptor agonists, and these agents have minimal effects on airway inflammation and airway remodeling in vivo, despite reports that they can inhibit individual features of airway remodeling (e.g. airway smooth muscle proliferation) in vitro. Inhaled corticosteroids represent the mainstay for the control of several allergic diseases, including persistent mild, moderate and severe asthma, and are well known for their broad-spectrum of activities that reduce the intensity of inflammatory processes that characterize asthma. Unfortunately, however, several features of airway inflammation (e.g. neutrophilia) can be relatively insensitive to corticosteroid treatment. Moreover, corticosteroids are only partially effective in inhibiting features of airway remodeling. Thus, although corticosteroids effectively prevent several features of airway remodeling (fibrosis, airway smooth muscle thickening, mucus gland hypertrophy) they are poorly effective in reversing airway wall remodeling. The limitations associated with β2-adrenoceptor agonist and corticosteroid treatment have urged to the investigation and identification of alternative drug targets. Amongst those, Rho kinase has emerged as a potential target for the treatment of airway hyperresponsiveness in asthma. Rho-kinase is an effector molecule of RhoA, a monomeric GTP-binding protein, and causes Ca2+ sensitization via inactivation of myosin phosphatase. The major physiological functions of Rho-kinase include contraction, migration, and proliferation in cells. These actions are thought to be related to the pathophysiological features of asthma, i.e., airflow limitation, airway hyperresponsiveness, β-adrenergic desensitization, eosinophil recruitment and airway remodeling.

6. JAK

The Janus Kinase (JAK) family plays a role in the cytokine-dependent regulation of proliferation and function of cells involved in immune response. Currently, there are four known mammalian JAK family members: JAK1 (also known as Janus kinase-1), JAK2 (also known as Janus kinase-2), JAK3 (also known as Janus kinase, leukocyte; JAKL; L-JAK and Janus kinase-3) and TYK2 (also known as protein-tyrosine kinase T). The JAK proteins range in size from 120 to 140 kDa and comprise seven conserved JAK homology (JH) domains; one of these is a functional catalytic kinase domain, and another is a pseudokinase domain potentially serving a regulatory function and/or serving as a docking site for STATs.

Blocking signal transduction at the level of the JAK kinases holds promise for developing treatments for many diseases including inflammatory diseases, autoimmune diseases and myeloproliferative diseases, and human cancers, to name a few. Modulators or inhibition of the JAK kinases can have therapeutic benefits in patients suffering from skin immune disorders such as psoriasis, and skin sensitization. Accordingly, inhibitors of Janus kinases or related kinases are widely sought and several publications report effective classes of compounds. Further examples of JAK-associated diseases include autoimmune diseases such as multiple sclerosis, rheumatoid arthritis, juvenile arthritis, psoriatic arthritis, type I diabetes, lupus, psoriasis, inflammatory bowel disease, ulcerative colitis, Crohn's disease, myasthenia gravis, immunoglobulin nephropathies, autoimmune thyroid disorders, and the like. In some embodiments, the autoimmune disease is an autoimmune bullous skin disorder such as pemphigus vulgaris (PV) or bullous pemphigoid (BP). Further examples of JAK-associated diseases include allergic conditions such as asthma, food allergies, atopic dermatitis and rhinitis. Further examples of JAK-associated diseases include viral diseases such as Epstein Barr Virus (EBV), Hepatitis B, Hepatitis C, HIV, HTLV 1, Varicella-Zoster Virus (VZV) and Human Papilloma Virus (HPV).

Further JAK-associated diseases include inflammation and inflammatory diseases. Example inflammatory diseases include inflammatory diseases of the eye (e.g., iritis, uveitis, scleritis, conjunctivitis, or related disease), inflammatory diseases of the respiratory tract (e.g., the upper respiratory tract including the nose and sinuses such as rhinitis or sinusitis or the lower respiratory tract including bronchitis, chronic obstructive pulmonary disease, and the like), inflammatory myopathy such as myocarditis, and other inflammatory diseases.

7. Acoustic Biosensors

Acoustic biosensors such as quartz crystal resonators utilize acoustic waves to characterize cellular responses. The acoustic waves are generally generated and received using piezoelectric. An acoustic biosensor is often designed to operate in a resonant type sensor configuration. In a typical setup, thin quartz discs are sandwiched between two gold electrodes. Application of an AC signal across electrodes leads to the excitation and oscillation of the crystal, which acts as a sensitive oscillator circuit. The output sensor signals are the resonance frequency and motional resistance. The resonance frequency is largely a linear function of total mass of adsorbed materials when the biosensor surface is rigid. Under liquid environments the acoustic sensor response is sensitive not only to the mass of bound molecules, but also to changes in viscoelastic properties and charge of the molecular complexes formed or live cells. By measuring the resonance frequency and the motion resistance of cells associated with the crystals, cellular processes including cell adhesion and cytotoxicity can be studied in real time.

8. Electrical Biosensors

Electrical biosensors employ impedance to characterize cellular responses including cell adhesion. In a typical setup, live cells are brought in contact with a biosensor surface wherein an integrated electrode array is embedded. A small AC pulse at a constant voltage and high frequency is used to generate an electric field between the electrodes, which are impeded by the presence of cells. The electric pulses are generated onsite using the integrated electric circuit; and the electrical current through the circuit is followed with time. The resultant impedance is a measure of changes in the electrical conductivity of the cell layer. The cellular plasma membrane acts as an insulating agent forcing the current to flow between or beneath the cells, leading to quite robust changes in impedance. Impedance-based measurements have been applied to study a wide range of cellular events, including cell adhesion and spreading, cell micromotion, cell morphological changes, and cell death, and cell signaling.

9. Optical Biosensors

Optical biosensors primarily employ a surface-bound electromagnetic wave to characterize cellular responses. The surface-bound waves can be achieved either on gold substrates using either light excited surface plasmons (surface plasmon resonance, SPR) or on dielectric substrate using diffraction grating coupled waveguide mode resonances (resonance waveguide grating, RWG). For SPR including mid-IR SPR, the readout is the resonance angle at which a minimal in intensity of reflected light occurs. Similarly, for RWG biosensor including photonic crystal biosensors, the readout is the resonance angle or wavelength at which a maximum incoupling efficiency is achieved. The resonance angle or wavelength is a function of the local refractive index at or near the sensor surface. Unlike SPR which is limited to a few of flow channels for assaying, RWG biosensors are amenable for high throughput screening (HTS) and cellular assays, due to recent advancements in instrumentation and assays. In a typical RWG, the cells are directly placed into a well of a microtiter plate in which a biosensor consisting of a material with high refractive index is embedded. Local changes in the refractive index lead to a dynamic mass redistribution (DMR) signal of live cells upon stimulation. These biosensors have been used to study diverse cellular processes including receptor biology, ligand pharmacology, and cell adhesion.

The present invention preferably uses resonant waveguide grating biosensors, such as Corning Epic® systems. Epic® system includes the commercially available wavelength integration system, or angular interrogation system or swept wavelength imaging system (Corning Inc., Corning, N.Y.). The commercial system consists of a temperature-control unit, an optical detection unit, with an on-board liquid handling unit with robotics, or an external liquid accessory system with robotics. The detection unit is centered on integrated fiber optics, and enables kinetic measures of cellular responses with a time interval of ˜7 or 15 sec. The compound solutions were introduced by using either the on-board liquid handling unit, or the external liquid accessory system; both of which use conventional liquid handling systems. Different RWG biosensor systems including high resolution imaging systems as well as high acquisition optical biosensor systems can also be used.

10. Biosensors and Biosensor Cellular Assays

Label-free cell-based assays generally employ a biosensor to monitor molecule-induced responses in living cells. The molecule can be naturally occurring or synthetic, and can be a purified or unpurified mixture. A biosensor typically utilizes a transducer such as an optical, electrical, calorimetric, acoustic, magnetic, or like transducer, to convert a molecular recognition event or a molecule-induced change in cells contacted with the biosensor into a quantifiable signal. These label-free biosensors can be used for molecular interaction analysis, which involves characterizing how molecular complexes form and disassociate over time, or for cellular response, which involves characterizing how cells respond to stimulation. The biosensors that are applicable to the present methods can include, for example, optical biosensor systems such as surface plasmon resonance (SPR) and resonant waveguide grating (RWG) biosensors including photonic crystal biosensors, resonant mirrors, ellipsometers, and electric biosensor systems such as bioimpedance systems.

i. SPR Biosensors and Systems

SPR relies on a prism to direct a wedge of polarized light, covering a range of incident angles, into a planar glass substrate bearing an electrically conducting metallic film (e.g., gold) to excite surface plasmons. The resultant evanescent wave interacts with, and is absorbed by, free electron clouds in the gold layer, generating electron charge density waves (i.e., surface plasmons) and causing a reduction in the intensity of the reflected light. The resonance angle at which this intensity minimum occurs is a function of the refractive index of the solution close to the gold layer on the opposing face of the sensor surface

ii. RWG Biosensors and Systems

An RWG biosensor can include, for example, a substrate (e.g., glass), a waveguide thin film with an embedded grating or periodic structure, and a cell layer. The RWG biosensor utilizes the resonant coupling of light into a waveguide by means of a diffraction grating, leading to total internal reflection at the solution-surface interface, which in turn creates an electromagnetic field at the interface. This electromagnetic field is evanescent in nature, meaning that it decays exponentially from the sensor surface; the distance at which it decays to 1/e of its initial value is known as the penetration depth and is a function of the design of a particular RWG biosensor, but is typically on the order of about 200 nm. This type of biosensor exploits such evanescent wave to characterize ligand-induced alterations of a cell layer at or near the sensor surface.

RWG instruments can be subdivided into systems based on angle-shift or wavelength-shift measurements. In a wavelength-shift measurement, polarized light covering a range of incident wavelengths with a constant angle is used to illuminate the waveguide; light at specific wavelengths is coupled into and propagates along the waveguide. Alternatively, in angle-shift instruments, the sensor is illuminated with monochromatic light and the angle at which the light is resonantly coupled is measured.

The resonance conditions are influenced by the cell layer (e.g., cell confluency, adhesion and status), which is in direct contact with the surface of the biosensor. When a ligand or an analyte interacts with a cellular target (e.g., a GPCR, an ion channel, a kinase) in living cells, any change in local refractive index within the cell layer can be detected as a shift in resonant angle (or wavelength).

The Corning® Epic® system uses RWG biosensors for label-free biochemical or cell-based assays (Corning Inc., Corning, N.Y.). The Epic® System consists of an RWG plate reader and SBS (Society for Biomolecular Screening) standard microtiter plates. The detector system in the plate reader exploits integrated fiber optics to measure the shift in wavelength of the incident light, as a result of ligand-induced changes in the cells. A series of illumination-detection heads are arranged in a linear fashion, so that reflection spectra are collected simultaneously from each well within a column of a 384-well microplate. The whole plate is scanned so that each sensor can be addressed multiple times, and each column is addressed in sequence. The wavelengths of the incident light are collected and used for analysis. A temperature-controlling unit can be included in the instrument to minimize spurious shifts in the incident wavelength due to the temperature fluctuations. The measured response represents an averaged response of a population of cells. Varying features of the systems can be automated, such as sample loading, and can be multiplexed, such as with a 96 or 386 well microtiter plate. Liquid handling is carried out by either on-board liquid handler, or an external liquid handling accessory. Specifically, molecule solutions are directly added or pipetted into the wells of a cell assay plate having cells cultured in the bottom of each well. The cell assay plate contains certain volume of assay buffer solution covering the cells. A simple mixing step by pipetting up and down certain times can also be incorporated into the molecule addition step.

iii. Electrical Biosensors and Systems

Electrical biosensors consist of a substrate (e.g., plastic), an electrode, and a cell layer. In this electrical detection method, cells are cultured on small gold electrodes arrayed onto a substrate, and the system's electrical impedance is followed with time. The impedance is a measure of changes in the electrical conductivity of the cell layer. Typically, a small constant voltage at a fixed frequency or varied frequencies is applied to the electrode or electrode array, and the electrical current through the circuit is monitored over time. The ligand-induced change in electrical current provides a measure of cell response Impedance measurement for whole cell sensing was first realized in 1984. Since then, impedance-based measurements have been applied to study a wide range of cellular events, including cell adhesion and spreading, cell micromotion, cell morphological changes, and cell death. Classical impedance systems suffer from high assay variability due to use of a small detection electrode and a large reference electrode. To overcome this variability, the latest generation of systems, such as the CellKey system (MDS Sciex, South San Francisco, Calif.) and RT-CES (ACEA Biosciences Inc., San Diego, Calif.), utilize an integrated circuit having a microelectrode array.

iv. High Spatial Resolution Biosensor Imaging Systems

Optical biosensor imaging systems, including SPR imaging systems, ellipsometry imaging systems, and RWG imaging systems, offer high spatial resolution, and can be used in embodiments of the disclosure. For example, SPR imager®II (GWC Technologies Inc) uses prism-coupled SPR, and takes SPR measurements at a fixed angle of incidence, and collects the reflected light with a CCD camera. Changes on the surface are recorded as reflectivity changes. Thus, SPR imaging collects measurements for all elements of an array simultaneously.

A swept wavelength optical interrogation system based on RWG biosensor for imaging-based application can be employed. In this system, a fast tunable laser source is used to illuminate a sensor or an array of RWG biosensors in a microplate format. The sensor spectrum can be constructed by detecting the optical power reflected from the sensor as a function of time as the laser wavelength scans, and analysis of the measured data with computerized resonant wavelength interrogation modeling results in the construction of spatially resolved images of biosensors having immobilized receptors or a cell layer. The use of an image sensor naturally leads to an imaging based interrogation scheme. 2 dimensional label-free images can be obtained without moving parts.

Alternatively, angular interrogation system with transverse magnetic or p-polarized TM₀ mode can also be used. This system consists of a launch system for generating an array of light beams such that each illuminates a RWG sensor with a dimension of approximately 200 μm×3000 μm or 200 μm×2000 μm, and a CCD camera-based receive system for recording changes in the angles of the light beams reflected from these sensors. The arrayed light beams are obtained by means of a beam splitter in combination with diffractive optical lenses. This system allows up to 49 sensors (in a 7×7 well sensor array) to be simultaneously sampled at every 3 seconds, or up to the whole 384well microplate to be simultaneously sampled at every 10 seconds.

Alternatively, a scanning wavelength interrogation system can also be used. In this system, a polarized light covering a range of incident wavelengths with a constant angle is used to illuminate and scan across a waveguide grating biosensor, and the reflected light at each location can be recorded simultaneously. Through scanning, a high resolution image across a biosensor can also be achieved.

v. Biosensor Parameters

A label-free biosensor such as RWG biosensor or bioimpedance biosensor is able to follow in real time ligand-induced cellular response. The non-invasive and manipulation-free biosensor cellular assays do not require prior knowledge of cell signaling. The resultant biosensor signal contains high information relating to receptor signaling and ligand pharmacology. Multi-parameters can be extracted from the kinetic biosensor response of cells upon stimulation. These parameters include, but not limited to, the overall dynamics, phases, signal amplitudes, as well as kinetic parameters including the transition time from one phase to another, and the kinetics of each phase (see Fang, Y., and Ferrie, A. M. (2008) “label-free optical biosensor for ligand-directed functional selectivity acting on β2 adrenoceptor in living cells”. FEBS Lett. 582, 558-564; Fang, Y., et al., (2005) “Characteristics of dynamic mass redistribution of EGF receptor signaling in living cells measured with label free optical biosensors”. Anal. Chem., 77, 5720-5725; Fang, Y., et al., (2006) “Resonant waveguide grating biosensor for living cell sensing”. Biophys. J., 91, 1925-1940).

For clustering or similarity analysis, the edge attributes (i.e., biosensor cellular response data) for each node (i.e., a molecule) can be different. For example, for a molecule profile (primary secondary) in a cell, an edge attribute can be a specific kinetic parameter (e.g., the amplitude or kinetics of a DMR event in a DMR signal), or a real value of a biosensor signal at a given time post simulation, or real values of a biosensor signal at multiple or all time points post stimulation. For a molecule biosensor secondary profile an edge attribute can also be a modulation percentage of a biosensor signal output parameter against a specific marker after normalized to the respective marker primary profile. As a result, the collective edge attribute represents an effective means to display the label-free pharmacology of a node molecule, such that the similarity of the molecule to a known molecule can be compared and determined based on the disclosed methods.

a. Biosensor Output Parameters

A number of different biosensor output parameters are discussed herein. For example, six parameters defining the kinetics of the stimulation-induced directional mass redistribution within the cells can be overall dynamics (i.e., shape), phases of the response (in the specific example of the EGF-induced DMR signal in quiescent A431 cells, there are three main phases relating to the cell response: Positive-Dynamic Mass Redistribution (P-DMR), Negative-Dynamic Mass Redistribution (N-DMR), and Recovery Positive-Dynamic Mass Redistribution (RP-DMR)), kinetics, total duration time of each phase, total amplitudes of each DMR event, and transition time from the P- to N-DMR phase, or from N-DMR to RP-DMR. Dynamic mass redistribution is often termed as dynamic cellular matter redistribution or directional mass redistribution. Other biosensor output parameters can be obtained from a resonant peak. For example, peak position, intensity, peak shape and peak width at half maximum (PWHM) can be used. Biosensor output parameters can also be obtained from the resonant band image of a biosensor. Five additional features: band shape, position, intensity, distribution and width. All of these parameters can be used independently or together for any given application of any cell assays using biosensors as disclosed herein. The use of the parameters in any subset or combination can produce a signature for a given assay or given variation on a particular assay, such as a signature for a cell receptor assay, and then a specific signature for an EGF receptor based assay.

(A) Parameters Related to the Kinetics of Stimulation-Induced Directional Mass Redistribution

There are a number of biosensor output parameters that are related to the kinetics of the stimulation-induced DMR. These parameters look at rates of change that occur to biosensor data output as a stimulatory event to the cell occurs. A stimulatory event is any event that can change the state of the cell, such as the addition of a molecule to the culture medium, the removal of a molecule from the culture medium, a change in temperature or a change in pH, or the introduction of radiation to the cell, for example. A stimulatory event can produce a stimulatory effect which is any effect, such as a directional mass redistribution, on a cell that is produced by a stimulatory event. The stimulatory event could be a molecule, a chemical, a biochemical, a biological, a polymer. The biochemical or biological could a peptide, a synthetic peptide or naturally occurring peptide. For example, many different peptides act as signaling molecules, including the proinflammatory peptide bradykinin, the protease enzyme thrombin, and the blood pressure regulating peptide angiotensin. While these three proteins are distinct in their sequence and physiology, and act through different cell surface receptors, they share in a common class of cell surface receptors called G-protein coupled receptors (GPCRs). Other polypeptide ligands of GPCRs include vasopressin, oxytocin, somatostatin, neuropeptide Y, GnRH, leutinizing hormone, follicle stimulating hormone, parathyroid hormone, orexins, urotensin II, endorphins, enkephalins, and many others. GPCRs belongs to a broad and diverse gene family that responds not only to peptide ligands but also small molecule neurotransmitters (acetylcholine, dopamine, serotonin and adrenaline), light, odorants, taste, lipids, nucleotides, and ions. The main signaling mechanism used by GPCRs is to interact with G-protein GTPase proteins coupled to downstream second messenger systems including intracellular calcium release and cAMP production. The intracellular signaling systems used by peptide GPCRs are similar to those used by all GPCRs, and are typically classified according to the G-protein they interact with and the second messenger system that is activated. For Gs-coupled GPCRs, activation of the G-protein Gs by receptor stimulates the downstream activation of adenylate cyclase and the production of cyclic AMP, while Gi-coupled receptors inhibit cAMP production. One of the key results of cAMP production is activation of protein kinase A. Gq-coupled receptors stimulate phospholipase C, releasing IP3 and diacylglycerol. IP3 binds to a receptor in the ER to cause the release of intracellular calcium, and the subsequent activation of protein kinase C, calmodulin-dependent pathways. In addition to these second messenger signaling systems for GPCRs, GPCR pathways exhibit crosstalk with other signaling pathways including tyrosine kinase growth factor receptors and map kinase pathways. Transactivation of either receptor tyrosine kinases like the EGF receptor or focal adhesion complexes can stimulate ras activation through the adaptor proteins She, Grb2 and Sos, and downstream Map kinases activating Erk1 and Erk2. Src kinases can also play an essential intermediary role in the activation of ras and map kinase pathways by GPCRs.”

It is possible that some stimulatory events can occur but there is no change in the data output. This situation is still a stimulatory event because the conditions of the cell have changed in some way that could have caused a directional mass redistribution or a change in the cell or cell culture.

It is understood that a particular signature can be determined for any assay or any cell condition as disclosed herein. There are numerous “signatures” disclosed herein for many different assays, but for any assay performed herein, the “signature” of that assay can be determined. It is also possible that there can be more than one “signatures” for any given assay and each can be determined as described herein. After collecting the biosensor output data and looking at one or more parameters, or the signature for the given assay can be obtained. It may be necessary to perform multiple experiments to identify the optimal signature and it may be necessary to perform the experiments under different conditions to find the optimal signature, but this can be done. It is understood that any of the method disclosed herein can have the step of “identifying” or “determining” or “providing”, for example, a signature added onto them.

(1) Overall Dynamics

One of the parameters that can be looked at is the overall dynamics of the data output. This overall dynamic parameter observes the complete kinetic picture of the data collection. One aspect of the overall dynamics that can be observed is a change in the shape of the curve produced by the data output over time. Thus the shape of the curve produced by the data output can either be changed or stay steady upon the occurrence of the stimulatory event. The direction of the changes indicates the overall mass distribution; for example, a positive-DMR (P-DMR) phase indicates the increased mass within the evanescent tail of the sensor; a net-zero DMR indicates that there is almost no net-change of mass within the evanescent tail of the sensor, whereas a negative-DMR indicates a net-deceased mass within the evanescent tail of the sensor.

The overall dynamics of a stimulation-induced cell response obtained using the optical biosensors can consist of a single phase (either P-DMR or N-DMR or net-zero-DMR), or two phases (e.g., the two phases could be any combinations of these three phases), or three phases, or multiple phases (e.g., more one P-DMR can be occurred during the time course).

(2) Phases of the Response

Another parameter that can observed as a function of time are the phase changes that occur in the data output. A label free biosensor produces a data output that can be graphed which will produce a curve. This curve will have transition points, for example, where the data turns from an increasing state to a decreasing state or vice versa. These changes can be called phase transitions and the time at which they occur and the shape that they take can be used, for example, as a biosensor output parameter. For example, there can be a P-DMR, a net-zero DMR, a N-DMR, or a RP-DMR. The amplitude of the P-DMR, N-DMR, and the RP-DMR can be measured as separate biosensor output parameters.

(3) Kinetics

Another biosensor output parameter can be the kinetics of any of the aspects of data output. For example, the rate at the completion of the phase transitions. For example, how fast the phase transition is completed or how long it does take to complete data output. Another example of the kinetics that can be measured would be the length of time for which an overall phase of the data output takes. Another example is the total duration of time of one or both of the P- and N-DMR phases. Another example is the rate or time in which it takes to acquire the total amplitudes of one or both of the P- and N-DMR phases. Another example can be the transition time τ from the P- to N-DMR phase. The kinetics of both P-DMR and N-DMR events or phases can also be measured.

(B) Parameters Related to the Resonant Peak

Resonant peaks of a given guided mode are a type of data output that occurs by looking at, for example, the intensity of the light vs. the angle of coupling of the light into the biosensor or the intensity of the light versus the wavelength of coupled light into the biosensor. The optical waveguide lightmode spectrum is a type of data output that occurs by looking at the intensity of the light vs. the angle of coupling of the light into the biosensor in a way that uses a broad range of angles of light to illuminate the biosensor and monitors the intensity of incoupled intensity as a function of the angle. In this spectrum, multiple resonant peaks of multiple guided modes are co-occurred. Since the principal behind the resonant peaks and OWLS spectra is the same, one can use the resonant peak of a given guided mode or OWLS spectra of multiple guided modes interchangeably, hi a biosensor, when either a particular wavelength of light occurs or when the light is produced such that it hits the biosensor at a particular angle, the light emitted from the light source becomes coupled into the biosensor and this coupling increases the signal that arises from the biosensor. This change in intensity as a function of coupling light angle or wavelength is called the resonant peak. Distinct given modes of the sensor can give rise to similar resonant peaks with different characteristics. There are a number of different parameters defining the resonant peak or resonant spectrum of a given mode that can be used related to this peak to assess DMR or cellular effects. A subset of these are discussed below.

(1) Peak Position

When the data output is graphed the peak of the resonance peak occurs, for example, at either a particular wavelength of light or at a particular angle of incidence for the light coupling into the biosensor. The angle or wavelength that this occurs at, the position, can change due to the mass redistribution or cellular event(s) in response to a stimulatory event. For example, in the presence of a potential growth factor for a particular receptor, such as the EGF receptor, the position of the resonant peak for the cultured cells can either increase or decrease the angle of coupling or the wavelength of coupling which will result in a change in the central position of the resonant peak. It is understood that the position of the peak intensity can be measured, and is a good point to measure, the position of any point along the resonant peak can also be measured, such as the position at 75% peak intensity or 50% peak intensity or 25% peak intensity, or 66% peak intensity or 45% peak intensity, for example (all levels from 1-100% of peak intensity are considered disclosed). However, when one uses a point other than the peak intensity, there will always be a position before the peak intensity and a position after the peak intensity that will be at, for example, 45% peak intensity. Thus, for any intensity, other than peak intensity, there will always be two positions within the peak where that intensity will occur. The position of these non-peak intensities can be utilized as biosensor output parameters, but one simply needs to know if the position of the intensity is a pre-peak intensity or a post-peak intensity.

(2) Intensity

Just as the position of a particular intensity of a resonant peak can used as a biosensor output parameter, so to the amount of intensity itself can also be a biosensor output parameter. One particularly relevant intensity is the maximum intensity of the resonant peak of a given mode. This magnitude of the maximum intensity, just like the position, can change based on the presence of a stimulatory event that has a particular effect on the cell or cell culture and this change can be measured and used a signature. Just as with the resonant peak position, the resonant peak intensity can also be measured at any intensity or position within the peak. For example, one could use as a biosensor output parameter, an intensity that is 50% of maximum intensity or 30% of maximum intensity or 70% of maximum intensity or any percent between 1% and 100% of maximum intensity. Likewise, as with the position of the intensity, if an intensity other than the maximum intensity will be used, such as 45% maximum intensity, there will always be two positions within the resonant peak that have this intensity. Just as with the intensity position parameter, using a non-maximum intensity can be done, one just must account for whether the intensity is a pre-maximum intensity or a post-maximum intensity.

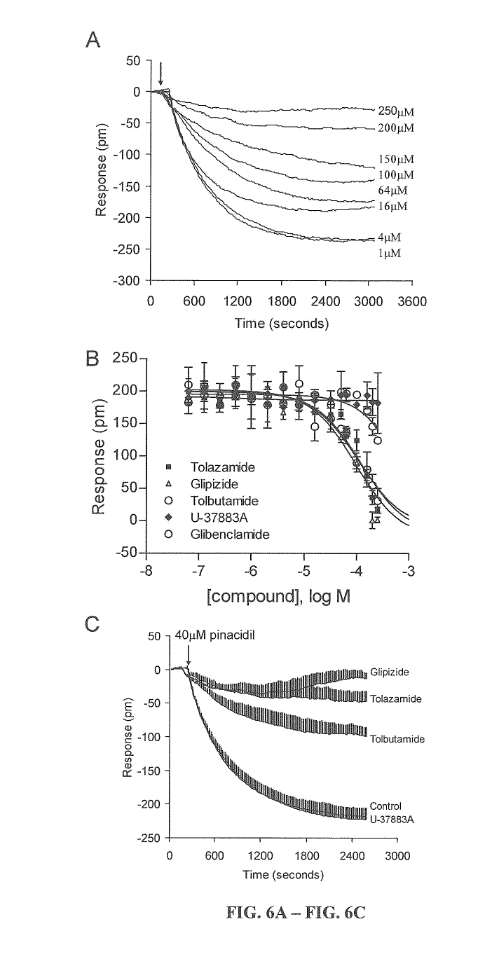

For example, the presence of both inhibitors and activators results in the decrease in the peak width at half maximum (PWHM) after culture when the original cell confluency is around 50% (at −50% confluency, the cells on the sensor surface tend to lead to a maximum PWHM value); however, another biosensor output parameter, such as the total angular shift (i.e., the central position of the resonant peak) can be used to distinguish an inhibitors from an activators from a molecule having no effect at all. The PWHM is length of a line drawn between the points on a peak that are at half of the maximum intensity (height) of the peak, as exampled in FIG. 6B. The inhibitors, for example, of cell proliferation, tend to give rise to angular shift smaller than the shift for cells with no treatment at all, whereas the activators tend to give rise to a bigger angular shift, as compared to the sensors having cells without any treatment at all, when the cell densities on all sensors are essentially identical or approximately the same. The potency or ability of the molecules that either inhibit (as inhibitors) or stimulate (as activator) cell proliferation can be determined by their effect on the PWHM value, given that the concentration of all molecules are the same. A predetermined value of the PWHM changes can be used to filter out the inhibitors or activators, in combination with the changes of the central position of the resonant peak. Depending on the interrogation system used to detect the resonant peak of a given mode, the unit or value of the PWHM could be varied. For example, for an angular interrogation system, the unit can be degrees. The change in the PWHM of degrees could be 1 thousandths, 2 thousandths, 3 thousandths, 5 thousandths, 7 thousandths, or thousandths, for example.

(3) Peak Shape

Another biosensor output parameter that can be used is the overall peak shape, or the shape of the peak “between or at certain intensities. For example, the shape of the peak at the half maximal peak intensity, or any other intensity (such as 30%, 40%, 70%, or 88%, or any percent between 20 and 100%) can be used as a biosensor output parameter. The shape can be characterized by the area of the peak either below or above a particular intensity. For example, at the half maximal peak intensity there is a point that is pre-peak intensity and a point that is post-peak intensity. A line can be drawn between these two points and the area above this line within the resonant peak or the area below the line within the resonant peak can be determined and become a biosensor output parameter. It is understood that the integrated area of a given peak can also be used to analyze the effect of molecules acting on cells.

Another shape related biosensor output parameter can be the width of the resonant peak for a particular peak intensity. For example, at the width of the resonant peak at the half maximal peak intensity (HMPW) can be determined by measuring the size of the line between the pre-peak intensity point on the resonant peak that is 50% of peak intensity and the point on the line that is post-peak which is at 50% peak intensity. This measurement can then be used as a biosensor output parameter. It is understood that the width of the resonant peak can be determined in this way for any intensity between 20 and 100% of peak intensity. (Examples of this can be seen through out the figures, such as FIG. 6B).

(C) Parameters Related to the Resonant Band Image of a Biosensor

To date, most optical biosensors monitor the binding of target molecules to the probe molecules immobilized on the sensor surface, or cell attachment or cell viability on the sensor surface one at a time. For the binding event or cell attachment or cell viability on multiple biosensors, researchers generally monitor these events in a time-sequential manner. Therefore, direct comparison among different sensors can be a challenge. Furthermore, these detection systems whether it is wavelength or angular interrogation utilize a laser light of a small spot (˜100-500 μm in diameter) to illuminate the sensor. The responses or resonant peaks represent an average of the cell responses from the illuminating area. For a 96 well biosensor microplate (e.g., Coming's Epic microplate), each RWG sensor is approximately 3×3 mm² and lies at the bottom of each well, whereas the sensor generally has a dimension of 1×1 mm² for a 384well microplate format. Therefore, the responses obtained using the current sensor technology only represent a small portion of the sensor surface. Ideally, a detection system should not only allow one to simultaneously monitor the responses of live cells adherent on multiple biosensors, but also allow signal interrogation from relatively large area or multiple areas of each sensor.

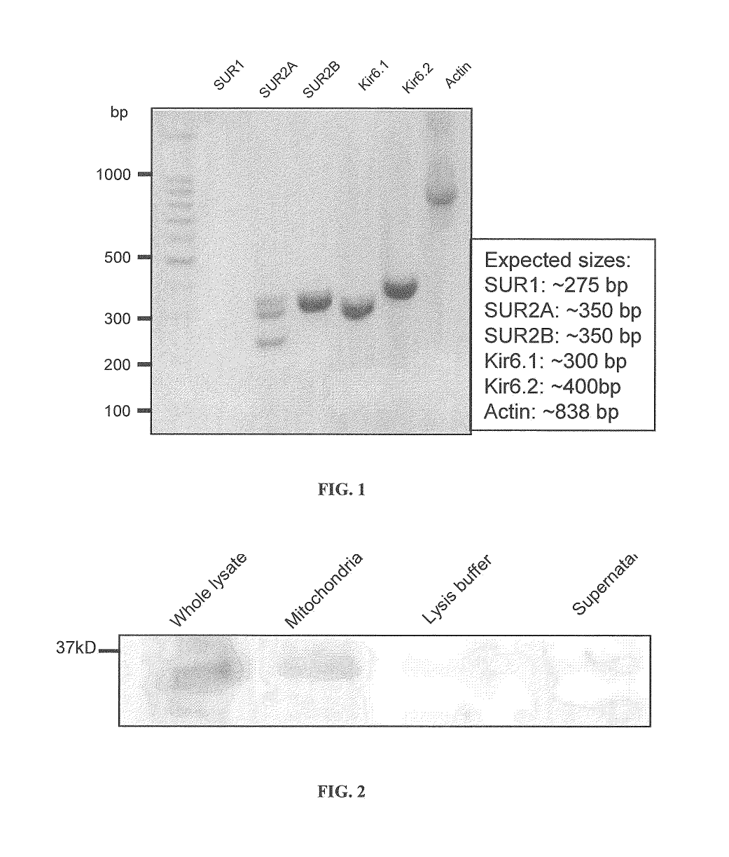

Resonant bands through an imaging optical interrogation system (e.g., a CCD camera) are a type of data output that occurs by looking at, for example, the intensity of the reflected (i.e., outcoupled) light at the defined location across a single sensor versus the physical position. Reflected light is directly related to incoupled light. Alternatively, a resonant band can be collected through a scanning interrogation system in a way that uses a small laser spot to illuminate the sensor, and scan across the whole sensor in one-dimension or two-dimension, and collect the resonant peak of a given guided mode. The resonant peaks or the light intensities as a function of position within the sensors can be finally reconsisted to form a resonant band of the sensor. In a biosensor, when either a particular wavelength of light occurs or when the light is produced such that it hits the biosensor at a particular angle, the outcoupled light varies as a function of the refractive index changes at/near the sensor surface and this changes lead to the shift of the characteristics of the resonant band of each sensor collected by the imaging system. Furthermore, the un-even attachment of the cells across the entire sensor after cultured can be directly visualized using the resonant band (See the circled resonant band in FIG. 1, for example). In an ideal multi-well biosensor microplate, the location of each sensor is relative to normalize to other biosensors; i.e., the sensors are aligned through the center of each well across the row or the column in the microplate. Therefore, the resonant band images obtained can be used as an internal reference regarding to the cell attachment or cellular changes in response to the stimulation. Therefore, such resonant band of each sensor of a given mode provides additional parameters that can be used related to this band to assess DMR or cellular effects. A subset of these are discussed below.

(1) Band Shape

Another biosensor output parameter that can be used is the shape of the resonant band of each biosensor of a given mode. The shape is defined by the intensity distribution across a large area of each sensor. The shape can be used as an indicator of the homogeneity of cells attached or cell changes in response to stimulation across the large area (for example, as shown in FIG. 1, each resonant band represents responses across the entire sensor with a dimension of ˜200 mm×3000 mm).

(2) Position

Similar to the position of the resonant peak of each sensor of a given mode, the position of each resonant band can be used as a biosensor output parameter. The intensity can be quantified using imaging software to generate the center position with maximum intensity of each band. Such position can be used to examine the cellular changes in response to stimulation or molecule treatment.

(3) Intensity

Just as the position of the resonant band, the intensity of the outcoupled light collected using the imaging system can be used as a biosensor output parameter. The average intensity of the entire band or absolute intensity of each pixel in the imaging band can be used to examine the quality of the cell attachment and evaluate the cellular response.

(4) Distribution

The distribution of the outcoupled light with a defined angle or wavelength collected using the imaging system can be used as a biosensor output parameter. This parameter can be used to evaluate the surface properties of the sensor itself when no cells or probe molecules immobilized, and to examine the quality of cell attachment across the illuminated area of the sensor surface. Again, this parameter can also be used for examining the uniformity of molecule effect on the cells when the cell density across the entire area is identical; or for examining the effect of the cell density on the molecule-induced cellular responses when the cell density is distinct one region from others across the illuminated area.

(5) Width

Just like the PWHM of a resonant peak of a given mode, the width of the resonant band obtained using the imaging system can be used as a biosensor output parameter. This parameter shares almost identical features, thus the useful information content, to those of the PWHM value of a resonant peak, except that one can obtain multiple band widths at multiple regions of the illuminated area of the sensor, instead of only one PWHM that is available for a resonant peak. Similar to other parameters obtained by the resonant band images, the width can be used for the above mentioned applications.

All of these parameters can be used independently or together for any given application of any cell assays using biosensors as disclosed herein. The use of the parameters in any subset or combination can produce a signature for a given assay or given variation on a particular assay, such as a signature for a cell receptor assay, and then a specific signature for an EGF receptor based assay.

vi. Dynamic Mass Redistribution (DMR) Signals in Living Cells

The cellular response to stimulation through a cellular target can be encoded by the spatial and temporal dynamics of downstream signaling networks. For this reason, monitoring the integration of cell signaling in real time can provide physiologically relevant information that is useful in understanding cell biology and physiology.

Optical biosensors including resonant waveguide grating (RWG) biosensors, can detect an integrated cellular response related to dynamic redistribution of cellular matters, thus providing a non-invasive means for studying cell signaling. All optical biosensors are common in that they can measure changes in local refractive index at or very near the sensor surface. In principle, almost all optical biosensors are applicable for cell sensing, as they can employ an evanescent wave to characterize ligand-induced change in cells. The evanescent-wave is an electromagnetic field, created by the total internal reflection of light at a solution-surface interface, which typically extends a short distance (hundreds of nanometers) into the solution at a characteristic depth known as the penetration depth or sensing volume.

Recently, theoretical and mathematical models have been developed that describe the parameters and nature of optical signals measured in living cells in response to stimulation with ligands. These models, based on a 3-layer waveguide system in combination with known cellular biophysics, link the ligand-induced optical signals to specific cellular processes mediated through a receptor.

Because biosensors measure the average response of the cells located at the area illuminated by the incident light, a highly confluent layer of cells can be used to achieve optimal assay results. Due to the large dimension of the cells as compared to the short penetration depth of a biosensor, the sensor configuration is considered as a non-conventional three-layer system: a substrate, a waveguide film with a grating structure, and a cell layer. Thus, a ligand-induced change in effective refractive index (i.e., the detected signal) can be, to first order, directly proportional to the change in refractive index of the bottom portion of the cell layer:

ΔN=S(C)Δn_{c}

where S(C) is the sensitivity to the cell layer, and Δn_{c} the ligand-induced change in local refractive index of the cell layer sensed by the biosensor. Because the refractive index of a given volume within a cell is largely determined by the concentrations of bio-molecules such as proteins, Δn_{c} can be assumed to be directly proportional to ligand-induced change in local concentrations of cellular targets or molecular assemblies within the sensing volume. Considering the exponentially decaying nature of the evanescent wave extending away from the sensor surface, the ligand-induced optical signal is governed by:

$$Δ N = S ( C ) α d {\sum }_{i} Δ {C}_{i} [ {e}^{\frac{- {z}_{i}}{Δ {Z}_{C}}} - {e}^{\frac{- {z}_{i + 1}}{Δ {Z}_{C}}} ]$$

where ΔZ_{c} is the penetration depth into the cell layer, α the specific refraction increment (about 0.18/mL/g for proteins), zi the distance where the mass redistribution occurs, and d an imaginary thickness of a slice within the cell layer. Here the cell layer is divided into an equal-spaced slice in the vertical direction. The equation above indicates that the ligand-induced optical signal is a sum of mass redistribution occurring at distinct distances away from the sensor surface, each with an unequal contribution to the overall response. Furthermore, the detected signal, in terms of wavelength or angular shifts, is primarily sensitive to mass redistribution occurring perpendicular to the sensor surface. Because of its dynamic nature, it also is referred to as dynamic mass redistribution (DMR) signal.

vii. Cells and Biosensors

Cells rely on multiple cellular pathways or machineries to process, encode and integrate the information they receive. Unlike the affinity analysis with optical biosensors that specifically measures the binding of analytes to a protein target, living cells are much more complex and dynamic.

To study cell signaling, cells can be brought in contact with the surface of a biosensor, which can be achieved through cell culture. These cultured cells can be attached onto the biosensor surface through three types of contacts: focal contacts, close contacts and extracellular matrix contacts, each with its own characteristic separation distance from the surface. As a result, the basal cell membranes are generally located away from the surface by ˜10-100 nm. For suspension cells, the cells can be brought in contact with the biosensor surface through either covalent coupling of cell surface receptors, or specific binding of cell surface receptors, or simply settlement by gravity force. For this reason, biosensors are able to sense the bottom portion of cells.

Cells, in many cases, exhibit surface-dependent adhesion and proliferation. In order to achieve robust cell assays, the biosensor surface can require a coating to enhance cell adhesion and proliferation. However, the surface properties can have a direct impact on cell biology. For example, surface-bound ligands can influence the response of cells, as can the mechanical compliance of a substrate material, which dictates how it will deform under forces applied by the cell. Due to differing culture conditions (time, serum concentration, confluency, etc.), the cellular status obtained can be distinct from one surface to another, and from one condition to another. Thus, special efforts to control cellular status can be necessary in order to develop biosensor-based cell assays.

Cells are dynamic objects with relatively large dimensions—typically in the range of tens of microns. Even without stimulation, cells constantly undergo micromotion—a dynamic movement and remodeling of cellular structure, as observed in tissue culture by time lapse microscopy at the sub-cellular resolution, as well as by bio-impedance measurements at the nanometer level.

Under un-stimulated conditions cells generally produce an almost net-zero DMR response as examined with a RWG biosensor. This is partly because of the low spatial resolution of optical biosensors, as determined by the large size of the laser spot and the long propagation length of the coupled light. The size of the laser spot determines the size of the area studied—and usually only one analysis point can be tracked at a time. Thus, the biosensor typically measures an averaged response of a large population of cells located at the light incident area. Although cells undergo micromotion at the single cell level, the large populations of cells give rise to an average net-zero DMR response. Furthermore, intracellular macromolecules are highly organized and spatially restricted to appropriate sites in mammalian cells. The tightly controlled localization of proteins on and within cells determines specific cell functions and responses because the localization allows cells to regulate the specificity and efficiency of proteins interacting with their proper partners and to spatially separate protein activation and deactivation mechanisms. Because of this control, under un-stimulated conditions, the local mass density of cells within the sensing volume can reach an equilibrium state, thus leading to a net-zero optical response. In order to achieve a consistent optical response, the cells examined can be cultured under conventional culture conditions for a period of time such that most of the cells have just completed a single cycle of division.

Living cells have exquisite abilities to sense and respond to exogenous signals. Cell signaling was previously thought to function via linear routes where an environmental cue would trigger a linear chain of reactions resulting in a single well-defined response. However, research has shown that cellular responses to external stimuli are much more complicated. It has become apparent that the information that cells receive can be processed and encoded into complex temporal and spatial patterns of phosphorylation and topological relocation of signaling proteins. The spatial and temporal targeting of proteins to appropriate sites can be crucial to regulating the specificity and efficiency of protein-protein interactions, thus dictating the timing and intensity of cell signaling and responses. Pivotal cellular decisions, such as cytoskeletal reorganization, cell cycle checkpoints and apoptosis, depend on the precise temporal control and relative spatial distribution of activated signal-transducers. Thus, cell signaling mediated through a cellular target such as G protein-coupled receptor (GPCR) typically proceeds in an orderly and regulated manner, and consists of a series of spatial and temporal events, many of which lead to changes in local mass density or redistribution in local cellular matters of cells. These changes or redistribution, when occurring within the sensing volume, can be followed directly in real time using optical biosensors.

viii. DMR Signal is a Physiological Response of Living Cells

Through comparison with conventional pharmacological approaches for studying receptor biology, it has been shown that when a ligand is specific to a receptor expressed in a cell system, the ligand-induced DMR signal is receptor-specific, dose-dependent and saturate-able. For a great number of G protein-coupled receptor (GPCR) ligands, the efficacies (measured by EC₅₀ values) are found to be almost identical to those measured using conventional methods. In addition, the DMR signals exhibit expected desensitization patterns, as desensitization and re-sensitization is common to all GPCRs. Furthermore, the DMR signal also maintains the fidelity of GPCR ligands, similar to those obtained using conventional technologies. In addition, the biosensor can distinguish full agonists, partial agonists, inverse agonists, antagonists, and allosteric modulators. Taken together, these findings indicate that the DMR is capable of monitoring physiological responses of living cells.

ix. DMR Signals Contain Systems Cell Biology Information of Ligand-Receptor Pairs in Living Cells

The stimulation of cells with a ligand leads to a series of spatial and temporal events, non-limiting examples of which include ligand binding, receptor activation, protein recruitment, receptor internalization and recycling, second messenger alternation, cytoskeletal remodeling, gene expression, and cell adhesion changes. Because each cellular event has its own characteristics (e.g., kinetics, duration, amplitude, mass movement), and the biosensor is primarily sensitive to cellular events that involve mass redistribution within the sensing volume, these cellular events can contribute differently to the overall DMR signal. Chemical biology, cell biology and biophysical approaches can be used to elucidate the cellular mechanisms for a ligand-induced DMR signal. Recently, chemical biology, which directly uses chemicals for intervention in a specific cell signaling component, has been used to address biological questions. This is possible due to the identification of a great number of modulators that specifically control the activities of many different types of cellular targets. This approach has been adopted to map the signaling and its network interactions mediated through a receptor, including epidermal growth factor (EGF) receptor, and G_{q}- and Gₛ-coupled receptors.

EGFR belongs to the family of receptor tyrosine kinases. EGF binds to and stimulates the intrinsic protein-tyrosine kinase activity of EGFR, initiating a signal transduction cascade, principally involving the MAPK, Akt and JNK pathways. Upon EGF stimulation, there are many events leading to mass redistribution in A431 cells—a cell line endogenously over-expressing EGFRs. It is known that EGFR signaling depends on cellular status. As a result, the EGF-induced DMR signals are also dependent on the cellular status. In quiescent cells obtained through 20 hr culturing in 0.1% fetal bovine serum, EGF stimulation leads to a DMR signal with three distinct and sequential phases: (i) a positive phase with increased signal (P-DMR), (ii) a transition phase, and (iii) a decay phase (N-DMR). Chemical biology and cell biology studies show that the EGF-induced DMR signal is primarily linked to the Ras/MAPK pathway, which proceeds through MEK and leads to cell detachment. Two lines of evidence indicate that the P-DMR is mainly due to the recruitment of intracellular targets to the activated receptors at the cell surface. First, blockage of either dynamin or clathrin activity has little effect on the amplitude of the P-DMR event. Dynamin and clathrin, two downstream components of EGFR activation, play crucial roles in executing EGFR internalization and signaling Second, the blockage of MEK activity partially attenuates the P-DMR event. MEK is an important component in the MAPK pathway, which first translocates from the cytoplasm to the cell membrane, followed by internalization with the receptors, after EGF stimulation.

On the other hand, the N-DMR event is due to cell detachment and receptor internalization. Fluorescent images show that EGF stimulation leads to a significant number of receptors internalized and cell detachment. It is known that blockage of either receptor internalization or MEK activity prevents cell detachment, and receptor internalization requires both dynamin and clathrin. This indicates that blockage of either dynamin or clathrin activity should inhibit both receptor internalization and cell detachment, while blockage of MEK activity should only inhibit cell detachment, but not receptor internalization. As expected, either dynamin or clathrin inhibitors completely inhibit the EGF-induced N-DMR (˜100%), while MEK inhibitors only partially attenuate the N-DMR (˜80%). Fluorescent images also confirm that blocking the activity of dynamin, but not MEK, impairs the receptor internalization.

x. DMR Signals Contain Systems Cell Pharmacology Information of a Ligand Acting on Living Cells

Since the DMR signal is an integrated cellular response consisting of contributions of many cellular events involving dynamic redistribution of cellular matters within the bottom portion of cells, a ligand-induced biosensor signal, such as a DMR signal contains systems cell pharmacology information. It is known that GPCRs often display rich behaviors in cells, and that many ligands can induce operative bias to favor specific portions of the cell machinery and exhibit pathway-biased efficacies. Thus, it is highly possibly that a ligand can have multiple efficacies, depending on how cellular events downstream of the receptor are measured and used as readout(s) for the ligand pharmacology. It is difficult in practice for conventional cell assays, which are mostly pathway-biased and assay only a single signaling event, to systematically represent the signaling potentials of GPCR ligands. However, because label-free biosensors cellular assays do not require prior knowledge of cell signaling, and are pathway-unbiased and pathway-sensitive, these biosensor cellular assays are amenable to studying ligand-selective signaling as well as systems cell pharmacology of any ligands.

xi. Label-Free Biosensors and Biosensor-Based Cell Assays for Ion Channel Modulators

Label-free cell-based assays generally employ a biosensor to monitor compound-induced responses in living cells. The compound can be naturally occurring or synthetic, purified or unpurified mixture. A biosensor typically utilizes a transducer such as an optical, electrical, calorimetric, acoustic, magnetic, or like transducer, to convert a molecular recognition event or a ligand-induced change in cells contacted with the biosensor into a quantifiable signal. The biosensors that are applicable to the present invention include, but not limited to, optical biosensor systems such as surface plasmon resonance (SPR) and resonant waveguide grating (RWG) biosensors, resonant mirrors, or ellipsometer, and electric biosensor systems such as bioimpedance systems.

Ion channels are important drug targets because they play a crucial role in controlling a very wide spectrum of physiological processes, and because their dysfunction can lead to pathophysiology. Historically, however, development of drugs targeting this protein class has been difficult. New, functional, high throughput screening (HTS) strategies developed to identify tractable lead structures, which typically are not abundant in small molecule libraries, have yielded promising results. Automated cell-based HTS assays can be configured for many different types of ion channels using fluorescence methods to monitor either changes in membrane potential or intracellular calcium with high density format plate readers. New automated patch clamp technologies provide secondary screens to confirm the activity of hits at the channel level, to determine selectivity across ion channel superfamilies, and to provide insight into mechanism of action. The same primary and secondary assays effectively support medicinal chemistry lead development. However, these approaches rarely provide insights how ion channel modulation can influence cell function and physiology.

### B. Methods

The methods disclosed herein, as well as the compositions and compounds which can be used in the methods, can arise from a number of different classes, such as materials, substance, molecules, and ligands. Also disclosed is a specific subset of these classes, unique to label free biosensor assays, called markers, for example, pinacidil as a marker for K_{ATP} channel activation.

It is understood that mixtures of these classes, such as a molecule mixture are also disclosed and can be used in the disclosed methods.

In certain methods, unknown molecules, test molecules, drug candidate molecules as well as known molecules can be used.

In certain methods or situations, modulating or modulators play a role, such as K_{ATP} modulators, JAK modulators, or ROCK modulators, as well as potentials of all of these. Likewise, known modulators can be used.

In certain methods, as well as compositions, cells are involved, as well as cell lines, cell panels, cellular targets which can produce cellular responses from cellular processes, for example. Cells can undergo culturing and cell cultures can be used as discussed herein.

The methods disclosed herein involve assays that use biosensors. In certain assays, they are performed in either an agonism or antagonism mode. Often the assays involve treating cells with one or more classes, such as a material, a substance, or a molecule. It is also understood that subjects can be treated as well, as discuss herein.

In certain methods, contacting between a molecule, for example, and a cell can take place. In the disclosed methods, responses, such as cellular response, which can manifest as a biosensor response, such as a DMR response, can be detected. These and other responses can be assayed. In certain methods the signals from a biosensor can be robust biosensor signals or robust DMR signals.

The disclosed methods utilizing label free biosensors can produce profiles, such as primary profiles, secondary profiles, and modulation profiles. These profiles and others can be used for making determinations about molecules, for example, and can be used with any of the classes discussed herein.

Also disclosed are libraries and panels of compounds or compositions, such as molecules, cells, materials, or substances disclosed herein. Also disclosed are specific panels, such as marker panels and cell panels.

The disclosed methods can utilize a variety of aspects, such as biosensor signals, DMR signals, normalizing, controls, positive controls, modulation comparisons, Indexes, Biosensor Indexes, DMR indexes, Molecule biosensor indexes, molecule DMR indexes, molecule indexes, modulator biosensor indexes, modulator DMR indexes, molecule modulation indexes, known modulator biosensor indexes, known modulator DMR indexes, marker biosensor indexes, marker DMR indexes, modulating the biosensor signal of a marker, modulating the DMR signal, potentiating, and similarity of indexes.

Any of the compositions, compounds, or anything else disclosed herein can be characterized in any way disclosed herein.

Disclosed are methods that rely on characterizations, such as higher and inhibit and like words.

In certain methods, receptors or cellular targets are used. Certain methods can provide information about signaling pathway(s) as well as molecule-treated cells and other cellular processes.

In certain embodiments, a certain potency or efficacy becomes a characteristic, and the direct action (of a drug candidate molecule, for example) can be assayed.

1. Methods to Screen K_{ATP} Modulators and mito-K_{ATP} as a Drug Target

Disclosed herein are methods of using mitochondria ATP-sensitive potassium ion channel (mito-K_{ATP}) as a drug target. In some embodiments, the methods can identify compounds that can prevent or treat liver diseases. In some embodiments, the compounds are mito-K_{ATP} channel modulators. Also disclosed herein are methods of using label-free biosensor cellular assays to screen for mito-K_{ATP} channel modulators in liver cells.

Also disclosed herein are methods to screen mito-K_{ATP} ion channel modulators in liver cells. In some embodiments, the screening is performed using label-free assays. Label-free assay can rely on the use of a known K_{ATP} opener as a reference. In some embodiments, the K_{ATP} opener is pinacidil. As shown according to the disclosed methods, pinacidil provides a robust dynamic mass redistribution (DMR) signal in transformed liver cell line HepG2C3A. The pinacidil DMR signal in liver cells can be used to screen mito-K_{ATP} modulators, including mito-K_{ATP} pathway modulators.

Also disclosed are methods of using of mito-K_{ATP} modulators for treating or preventing liver diseases. As shown according to the disclosed methods, the pinacidil DMR signal in the liver cell line HepG2C3A is associated with Kir6.2/SUR2 K_{ATP} ion channels, and the K_{ATP} ion channels are mostly located within mitochondria. The pinacidil DMR signal can be linked to actin remodeling, ROCK activity and JAK activity. The mito-K_{ATP} modulators can also suppress the induction of CYP3A4 enzymatic activity induced by rifampin, a well-known liver toxic drug. Thus, mito-K_{ATP} channels can be a druggable target for treating or preventing liver diseases.

Also disclosed herein are methods of assaying a molecule comprising the steps: a. culturing a K_{ATP} cell line on a substrate surface, wherein the biosensor surface is used in a label free biosensor analysis, b. incubating the cell line with the molecule producing a molecule treated cell line, c. analyzing the molecule treated cell line with a label free biosensor producing a molecule data output, d. comparing the molecule data output to a known K_{ATP} modulator data output in the same cell line, producing a molecule-K_{ATP} modulator comparison.

Also disclosed herein are methods of assaying a molecule comprising the steps: a. culturing a K_{ATP} cell line on a biosensor surface, wherein the biosensor surface is used in a label free biosensor analysis, b. incubating the cell line with a marker and the molecule producing an incubating cell line, c. analyzing the incubating cell line with a label free biosensor producing a marker-molecule data output, and d. comparing the marker-molecule data output to a marker-K_{ATP} modulator data output in the same cell line, producing a marker-molecule/marker-K_{ATP} modulator comparison.

Also disclosed herein are methods of assaying a molecule comprising the steps: a. culturing four different cell lines on a biosensor surface, wherein the biosensor surface is used in a label free biosensor analysis, wherein the four cell lines are A431, A549, HT29, and HepG2, b. incubating each cell line with the molecule producing four incubating cell lines, c. analyzing each incubating cell line with a label free biosensor producing a molecule data output for each incubating cell line, and d. comparing the molecule data output to a ROCK inhibitor data output in the same cell line, producing a molecule-ROCK inhibitor comparison for each cell line.

Also disclosed herein are methods of treating a subject comprising, administering a K_{ATP} modulator to the subject wherein the subject is in need of treatment for a liver disease.

Also disclosed herein are methods of reducing liver toxicity in a subject comprising, administering a KCO to the subject such that the KCO functions to decrease the liver toxicity of a drug given to the subject.

In some embodiments, the K_{ATP} cell line can comprise a mitochondria ATP-sensitive potassium ion channel (mito-K_{ATP}).

In some embodiments, the cell line can comprise a liver cell.

In some embodiments, the liver cell can comprises a hepatocyte cell.

In some embodiments, the liver cell can be infected with a hepatis virus. In some embodiments, hepatis virus can be hepatitis A, B, C, D, or E, herpes simplex, cytomegalovirus, Epstein-Barr, yellow fever virus, or adenoviruses.

In some embodiments, cells can be obtained from a source infected with a non-viral infection.

In some embodiments, the non-viral infection can comprise toxoplasma, Leptospira, Q fever or Rocky Mountain spotted fever.

In some embodiments, the cells can obtained from a source having been or is affected by a chemical, toxin, or drug.

In some embodiments, the chemical or toxin can comprise alcohol, eparacetamol, amoxycillin, antituberculosis medicines, minocycline, methyldopa, nitrofurantoin, isoniazid or ketoconazole.

In some embodiments, the known K_{ATP} modulator data output can be produced by incubating the K_{ATP} modulator with the cultured K_{ATP} cell line and analyzing the incubated cell line with a label free biosensor producing a K_{ATP} modulator data output.

In some embodiments, the methods can further comprise identifying a potential K_{ATP} modulator when the comparison indicates that the molecule data output and the K_{ATP} modulator data output are similar.

In some embodiments, the K_{ATP} cell line can be selected from a HepG2 or HepG2C3A cell line.

In some embodiments, the known K_{ATP} modulator can comprise a potassium channel opener (KCO).

In some embodiments, the KCO can comprise diazoxide, pinacidil, cromakalim or nicorandil.

In some embodiments, the K_{ATP} modulator can comprise a K_{ATP} inhibitor.

In some embodiments, the K_{ATP} inhibitor can comprise a sulfonylurea, or U-37883A.

In some embodiments, the sulfonylurea can comprise Tolbutamide, tolazamide or Glipizide.

In some embodiments, the marker-K_{ATP} modulator data output can be produced by incubating the marker and K_{ATP} modulator with a cultured K_{ATP} cell line and analyzing the incubated cell line with a label free biosensor producing a marker-K_{ATP} modulator data output.

In some embodiments, the methods can further comprise identifying a potential K_{ATP} modulator when the comparison indicates that the marker-molecule data output and the marker-K_{ATP} modulator data output are similar.

In some embodiments, the marker can comprise a ROCK1 modulator or ROCK2 modulator.

In some embodiments, the ROCK1 modulator or ROCK2 modulator can comprise a ROCK1 inhibitor or ROCK2 inhibitor.

In some embodiments, the ROCK1 inhibitor or ROCK2 inhibitor can comprise Y-27632.

In some embodiments, the marker can comprise a JAK modulator.

In some embodiments, the JAK modulator can comprise a JAK inhibitor.

In some embodiments, the JAK inhibitor can comprise AG490.

In some embodiments, the marker can comprise a cytochrome P450 enzyme modulator.

In some embodiments, the cytochrome P450 enzyme modulator can comprise a cytochrome P450 activator.

In some embodiments, cytochrome P450 enzyme can comprise CYP2D6 or CYP3A4.

In some embodiments, the cytochrome P450 activator can comprise rifampicin.

In some embodiments, the methods can further comprise assaying the molecule for ROCK pathway activity.

In some embodiments, the step of assaying can comprise, a. culturing a ROCK inhibitor responsive cell line on a surface, wherein the surface can be used in a label free biosensor analysis, b. incubating the cell line with the molecule producing an incubating cell line, c. analyzing the incubating cell line with a label free biosensor producing a molecule data output, and d. comparing the molecule data output to a known ROCK inhibitor data output in the same cell, producing a molecule-ROCK inhibitor comparison.

In some embodiments, the ROCK inhibitor responsive cell line can comprise a cell line in which inhibiting the basal activity of ROCKs by the known ROCK inhibitor produces a robust biosensor signal.

In some embodiments, the cell line can be selected from A431, A549, or HT29.

In some embodiments, the method can be performed independently with at least 2 markers.

In some embodiments, the marker can be added at a concentration of at least an EC70, an EC80, an EC 90, and EC95, and an EC100.

In some embodiments, the ROCK inhibitor can be Y27632 and the K_{ATP} modulator can be LY-294002.

In some embodiments, the ROCK inhibitor data output can be produced by incubating the ROCK inhibitor with each cell line and analyzing each incubated cell line with a label free biosensor producing a ROCK inhibitor data output for each cell line.

In some embodiments, the methods can further comprise producing a K_{ATP} modulator data output, and producing a molecule-K_{ATP} inhibitor comparison for each cell line.

In some embodiments, the methods can further comprise the step of performing an additional ion channel assay.

In some embodiments, the additional ion channel assay can comprise conventional or automated patch clamping.

In some embodiments, the K_{ATP} modulator can comprise a mito-K_{ATP} modulator.

In some embodiments, the liver disease can involve JAK or Rho kinase signaling downstream from the K_{ATP}.

In some embodiments, the K_{ATP} channel can be a Kir6.2 and SUR2 channel. In some embodiments, the KCO can be pinacidil.

### C. Definitions

Various embodiments of the disclosure will be described in detail with reference to drawings, if any. Reference to various embodiments does not limit the scope of the disclosure, which is limited only by the scope of the claims attached hereto. Additionally, any examples set forth in this specification are not intended to be limiting and merely set forth some of the many possible embodiments for the claimed invention.

1. A

As used in the specification and the appended claims, the singular forms “a,” “an” and “the” or like terms include plural referents unless the context clearly dictates otherwise. Thus, for example, reference to “a pharmaceutical carrier” includes mixtures of two or more such carriers, and the like.

2. Abbreviations

Abbreviations, which are well known to one of ordinary skill in the art, may be used (e.g., “h” or “hr” for hour or hours, “g” or “gm” for gram(s), “mL” for milliliters, and “rt” for room temperature, “nm” for nanometers, “M” for molar, and like abbreviations).

3. About

About modifying, for example, the quantity of an ingredient in a composition, concentrations, volumes, process temperature, process time, yields, flow rates, pressures, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture. Whether modified by the term “about” the claims appended hereto include equivalents to these quantities.

4. “Across the Panel of Cells and Against the Panels of Markers”

The phrase “across the panel of cells and against the panels of markers” refers to a systematic process to examine the primary profiles of a molecule acting on each cell in the panel of cells, as well as the modulation profiles of the molecule to modulate the panels of markers. For a marker/cell pair, the process starts with first examining the primary profile of a molecule independently acting on each type of cells, followed by examining the secondary profile of a maker in the presence of the molecule in the same cell. The term “against” is specifically used to manifest the ability of the molecule to modulate the marker-induced biosensor response.

5. Agonist

An agonist is a molecule or substance that produces an action, such as a molecule binding a receptor on a cell producing a response by the cell, which can be intracellular.

6. Antagonist

An antagonist is a molecule or substance that inhibits, such as blocks, an action, such as the action of an agonist, such as a molecule binding a receptor which prevents an agonist from binding, and thereby inhibits the action of the agonist.

7. Activator

An activator is anything that causes an increase in a state, relative to a basal state. For example, pinacidil is an activator of a K_{ATP} channel, and the binding of K_{ATP} to K_{ATP} channel causes a signaling event.

8. Assaying

Assaying, assay, or like terms refers to an analysis to determine a characteristic of a substance, such as a molecule or a cell, such as for example, the presence, absence, quantity, extent, kinetics, dynamics, or type of an a cell's optical or bioimpedance response upon stimulation with one or more exogenous stimuli, such as a ligand or marker. Producing a biosensor signal of a cell's response to a stimulus can be an assay.

9. Assaying the Response

“Assaying the response” or like terms means using a means to characterize the response. For example, if a molecule is brought into contact with a cell, a biosensor can be used to assay the response of the cell upon exposure to the molecule.

10. Attach

“Attach,” “attachment,” “adhere,” “adhered,” “adherent,” “immobilized”, or like terms generally refer to immobilizing or fixing, for example, a surface modifier substance, a compatibilizer, a cell, a ligand candidate molecule, and like entities of the disclosure, to a surface, such as by physical absorption, chemical bonding, and like processes, or combinations thereof. Particularly, “cell attachment,” “cell adhesion,” or like terms refer to the interacting or binding of cells to a surface, such as by culturing, or interacting with cell anchoring materials, compatibilizer (e.g., fibronectin, collagen, lamin, gelatin, polylysine, etc.), or both. “Adherent cells,” “immobilized cells”, or like terms refer to a cell or a cell line or a cell system, such as a prokaryotic or eukaryotic cell, that remains associated with, immobilized on, or in certain contact with the outer surface of a biosensor. Such types of cells after culturing can withstand or survive washing and medium exchanging processes staying adhered, a process that is prerequisite to many cell-based assays.

11. Agonism and Antagonism Mode

The agonism mode or like terms is the assay wherein the cells are exposed to a molecule to determine the ability of the molecule to trigger biosensor signals such as DMR signals, while the antagonism mode is the assay wherein the cells are exposed to a marker in the presence of a molecule to determine the ability of the molecule to modulate the biosensor signal of cells responding to the marker.

12. Biosensor

Biosensor or like terms refer to a device for the detection of an analyte that combines a biological component with a physicochemical detector component. The biosensor typically consists of three parts: a biological component or element (such as tissue, microorganism, pathogen, cells, or combinations thereof), a detector element (works in a physicochemical way such as optical, piezoelectric, electrochemical, thermometric, or magnetic), and a transducer associated with both components. The biological component or element can be, for example, a living cell, a pathogen, or combinations thereof. In embodiments, an optical biosensor can comprise an optical transducer for converting a molecular recognition or molecular stimulation event in a living cell, a pathogen, or combinations thereof into a quantifiable signal.

13. Biosensor Cellular Assay-Centered Cell Profile Pharmacology

A “biosensor cellular assay-centered cell profile pharmacology” or like terms is a method to determine the pharmacology of molecules using label-free biosensor cellular assays.

14. Biosensor Index

A “biosensor index” or like terms is an index made up of a collection of biosensor data. A biosensor index can be a collection of biosensor profiles, such as primary profiles, or secondary profiles. The index can be comprised of any type of data. For example, an index of profiles could be comprised of just an N-DMR data point, it could be a P-DMR data point, or both or it could be an impedence data point. It could be all of the data points associated with the profile curve.

15. Biosensor Response

A “biosensor response”, “biosensor output signal”, “biosensor signal” or like terms is any reaction of a sensor system having a cell to a cellular response. A biosensor converts a cellular response to a quantifiable sensor response. A biosensor response is an optical response upon stimulation as measured by an optical biosensor such as RWG or SPR or it is a bioimpedence response of the cells upon stimulation as measured by an electric biosensor. Since a biosensor response is directly associated with the cellular response upon stimulation, the biosensor response and the cellular response can be used interchangeably, in embodiments of disclosure.

16. Biosensor Signal

A “biosensor signal” or like terms refers to the signal of cells measured with a biosensor that is produced by the response of a cell upon stimulation.

17. Biosensor Surface

biosensor surface or like words is any surface of a biosensor which can have a cell cultured on it. The biosensor surface can be tissue culture treated, or extracellular matrix material (e.g., fibronectin, laminin, collagen, or the like) coated, or synthetic material (e.g, poly-lysine) coated.

18. Cell

Cell or like term refers to a small usually microscopic mass of protoplasm bounded externally by a semipermeable membrane, optionally including one or more nuclei and various other organelles, capable alone or interacting with other like masses of performing all the fundamental functions of life, and forming the smallest structural unit of living matter capable of functioning independently including synthetic cell constructs, cell model systems, and like artificial cellular systems.

A cell can include different cell types, such as a cell associated with a specific disease, a type of cell from a specific origin, a type of cell associated with a specific target, or a type of cell associated with a specific physiological function. A cell can also be a native cell, an engineered cell, a transformed cell, an immortalized cell, a primary cell, an embryonic stem cell, an adult stem cell, a cancer stem cell, or a stem cell derived cell.

Human consists of about 210 known distinct cell types. The numbers of types of cells can almost unlimited, considering how the cells are prepared (e.g., engineered, transformed, immortalized, or freshly isolated from a human body) and where the cells are obtained (e.g., human bodies of different ages or different disease stages, etc).

19. Cell Line

A “cell line” or like terms refers to cells that can be group together by at least one common characteristic and which have the ability to be passaged in culture.

20. Cellular Background

A “cellular background” or like terms is a type of cell having a specific state. For example, different types of cells have different cellular backgrounds (e.g., differential expression or organization of cellular receptors). A same type of cell but having different states also has different cellular backgrounds. The different states of the same type of cells can be achieved through culture (e.g., cell cycle arrested, or proliferating or quiescent states), or treatment (e.g., different pharmacological agent-treated cells).

21. Cell Culture

“Cell culture” or “cell culturing” refers to the process by which either prokaryotic or eukaryotic cells are grown under controlled conditions. “Cell culture” not only refers to the culturing of cells derived from multicellular eukaryotes, especially animal cells, but also the culturing of complex tissues and organs.

22. Cell Panel

A “cell panel” or like terms is a panel which comprises at least two types of cells. The cells can be of any type or combination disclosed herein.

23. Cellular Response

A “cellular response” or like terms is any reaction by the cell to a stimulation.

24. Cellular Process

A cellular process or like terms is a process that takes place in or by a cell. Examples of cellular process include, but not limited to, proliferation, apoptosis, necrosis, differentiation, cell signal transduction, polarity change, migration, or transformation.

25. Cellular Target

A “cellular target” or like terms is a biopolymer such as a protein or nucleic acid whose activity can be modified by an external stimulus. Cellular targets commonly are proteins such as enzymes, kinases, ion channels, and receptors.

26. Characterizing

Characterizing or like terms refers to gathering information about any property of a substance, such as a ligand, molecule, marker, or cell, such as obtaining a profile for the ligand, molecule, marker, or cell.

27. Comprise

Throughout the description and claims of this specification, the word “comprise” and variations of the word, such as “comprising” and “comprises,” means “including but not limited to,” and is not intended to exclude, for example, other additives, components, integers or steps.

28. Consisting Essentially of

“Consisting essentially of” in embodiments refers, for example, to a surface composition, a method of making or using a surface composition, formulation, or composition on the surface of the biosensor, and articles, devices, or apparatus of the disclosure, and can include the components or steps listed in the claim, plus other components or steps that do not materially affect the basic and novel properties of the compositions, articles, apparatus, and methods of making and use of the disclosure, such as particular reactants, particular additives or ingredients, a particular agents, a particular cell or cell line, a particular surface modifier or condition, a particular ligand candidate, or like structure, material, or process variable selected. Items that may materially affect the basic properties of the components or steps of the disclosure or may impart undesirable characteristics to the present disclosure include, for example, decreased affinity of the cell for the biosensor surface, aberrant affinity of a stimulus for a cell surface receptor or for an intracellular receptor, anomalous or contrary cell activity in response to a ligand candidate or like stimulus, and like characteristics.

29. Components

Disclosed are the components to be used to prepare the disclosed compositions as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these molecules may not be explicitly disclosed, each is specifically contemplated and described herein. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the disclosed compositions. Thus, if there are a variety of additional steps that can be performed it is understood that each of these additional steps can be performed with any specific embodiment or combination of embodiments of the disclosed methods.

30. Contacting

Contacting or like terms means bringing into proximity such that a molecular interaction can take place, if a molecular interaction is possible between at least two things, such as molecules, cells, markers, at least a compound or composition, or at least two compositions, or any of these with an article(s) or with a machine. For example, contacting refers to bringing at least two compositions, molecules, articles, or things into contact, i.e. such that they are in proximity to mix or touch. For example, having a solution of composition A and cultured cell B and pouring solution of composition A over cultured cell B would be bringing solution of composition A in contact with cell culture B. Contacting a cell with a ligand would be bringing a ligand to the cell to ensure the cell have access to the ligand.

It is understood that anything disclosed herein can be brought into contact with anything else. For example, a cell can be brought into contact with a marker or a molecule, a biosensor, and so forth.

31. Compounds and Compositions

Compounds and compositions have their standard meaning in the art. It is understood that wherever, a particular designation, such as a molecule, substance, marker, cell, or reagent compositions comprising, consisting of, and consisting essentially of these designations are disclosed. Thus, where the particular designation marker is used, it is understood that also disclosed would be compositions comprising that marker, consisting of that marker, or consisting essentially of that marker. Where appropriate wherever a particular designation is made, it is understood that the compound of that designation is also disclosed. For example, if particular biological material, such as EGF, is disclosed EGF in its compound form is also disclosed.

32. Control

The terms control or “control levels” or “control cells” or like terms are defined as the standard by which a change is measured, for example, the controls are not subjected to the experiment, but are instead subjected to a defined set of parameters, or the controls are based on pre- or post-treatment levels. They can either be run in parallel with or before or after a test run, or they can be a pre-determined standard. For example, a control can refer to the results from an experiment in which the subjects or objects or reagents etc are treated as in a parallel experiment except for omission of the procedure or agent or variable etc under test and which is used as a standard of comparison in judging experimental effects. Thus, the control can be used to determine the effects related to the procedure or agent or variable etc. For example, if the effect of a test molecule on a cell was in question, one could a) simply record the characteristics of the cell in the presence of the molecule, b) perform a and then also record the effects of adding a control molecule with a known activity or lack of activity, or a control composition (e.g., the assay buffer solution (the vehicle)) and then compare effects of the test molecule to the control. In certain circumstances once a control is performed the control can be used as a standard, in which the control experiment does not have to be performed again and in other circumstances the control experiment should be run in parallel each time a comparison will be made.

33. Cytochrome P450 Enzyme Modulator

A “Cytochrome P450 enzyme modulator” is any molecule that functions to modulate P450, increase or decrease P450 activity. Known P450 modulators include, but not limited to, rifampicin.

34. Cytochrome P450 Enzyme Activator

A “Cytochrome P450 enzyme activator” is any molecule that functions to modulate P450, increase P450 activity. Known P450 activators include, but not limited to, rifampicin.

35. Cytochrome P450 Enzyme Inhibitor

A “Cytochrome P450 enzyme inhibitor” is any molecule that functions to modulate P450, decrease P450 activity.

36. Data Output

A data output refers to the collected result occurring after performing an assay using an analytical machine, such as a label free biosensor. For example, the data output of a label free biosensor could be a DMR signal. It is understood that data output can be manipulated, for example, into an Index. It is also understood that there can be any kind of data output that the assay is performed with, such as a molecule, a K_{ATP} channel, Rho Kinase, Marker, inhibitor, K_{ATP} inhibitor, marker-molecule, marker-K_{ATP} inhibitor, etc. It is also understood that any two outputs can be compared, such as a molecule data output and a K_{ATP} inhibitor data output forming a molecule-K_{ATP} inhibitor comparison. Typically, such a comparison will be performed with analogous data outputs, such as a DMR data output to a DMR data output.

37. Defined Pathway(s)

A “defined pathway” or like terms is a specific pathway, such as G_{αq} pathway, G_{αs} pathway, G_{αi} pathway, G_{12/13}, EGFR (epidermal growth factor receptor) pathway, or PKC (protein kinase C) pathway.

38. Deregulated PI3K Pathway Cell Line

A deregulated PI3K pathway cell line is a cell line in which the PI3K pathway is hyperactivated, due to alteration of crucial signaling cascade protein(s) in the pathway. These alterations include, but not limited to, mutations of K-Ras (a upstream protein of PI3K) which lead to constitutive activation of Ras and PI3K in the unstimulated cells, or loss-of-function of PTEN (a downstream negative regulator of PI3K) which also lead to constitutive activation of PI3K. For example, a deregulated PI3K pathway cell line is the A549 cell line which contain a K-Ras mutant that is constitutively activated in the unstimulated cells (Krypuy, M., et al. “High resolution melting analysis for the rapid and sensitive detection of mutations in clinical samples: KRAS codon 12 and 13 mutations in non-small cell lung cancer”. BMC Cancer 2006, 6, e295).

Proteins involved in the PI3K pathway include, but not limited to, (1) AKT and PI3K family members and their Regulators: AKT1, AKT2, AKT3, APPL, BTK, CTMP, GNB1, GRB10, GRB2, HSPB1, HSPCA, HSPCB, ILK, INPP5D (SHIP), INPPL1, MAPK81P1(JIP1), MTCP1, PDK2, PDPK1, PIK3CA (p110a), PIK3CB (p110b), PIK3CG, PIK3R1(p85a), PIK3R2 (p85b), PIK3R3, PRKCA, PRKCB1, PRKCZ, PTEN, TCL1A, TCL1B; (2) IGF-1 or other RTK signaling pathway: CSNK2A1, ELK1, FOS, GRB2, HRAS, IGF1, IGF1R, IRS1, JUN, MAP2K1, MAPK3, MAPK8, PIK3CB, PTPN11, RAF1, KRAS, RASA1, SHC1, SOS1, SRF; (3) PI3K subunit p85-related regulation of actin organization and cell Migration: AICDA, CDC42, CUTL1, PAK1, PDGFRA, RAC1, RHOA, WASL, ZFYVE21; (4) PTEN dependent cell cycle arrest and apoptosis: AKT1, CDKN1B (p27), CUTL1, FASLG, FOXO3A, GRB2, ILK, ITGB1, MAPK1, MAPK3, PDK1, PDK2, PTEN, PTK2, RBL2, SHC1, SOS1, ZFYVE21; (5) BAD phosphorylation-related anti-apoptotic pathways: AKT1, ASAH1, BAD, CUTL1, GRB2, HRAS, IGF1R, IRS1, MAP2K1, MAPK1, MAPK3, PRKAR1B, RAF1, RPS6KA1, SHC1, SOS1, YWHAH, ZFYVE21; and (6) proteins involved in the mTOR signaling pathway: AKT1, CUTL1, EIF3S10, EIF4A1, EIF4B, EIF4E, EIF4EBP1, EIF4G1, FKBP1A, FRAP1, MKNK1, PDK1, PDK2, PR48, PTEN, RHEB, RPS6, RPS6 KB1, TSC1, TSC2, ZFYVE21.

39. Detect

Detect or like terms refer to an ability of the apparatus and methods of the disclosure to discover or sense a molecule- or a marker-induced cellular response and to distinguish the sensed responses for distinct molecules.

40. Direct Action (of a Drug Candidate Molecule)

A “direct action” or like terms is a result (of a drug candidate molecule“) acting independently on a cell.

41. DMR Signal

A “DMR signal” or like terms refers to the signal of cells measured with an optical biosensor that is produced by the response of a cell upon stimulation.

42. DMR Response

A “DMR response” or like terms is a biosensor response using an optical biosensor. The DMR refers to dynamic mass redistribution or dynamic cellular matter redistribution. A P-DMR is a positive DMR response, a N-DMR is a negative DMR response, and a RP-DMR is a recovery P-DMR response.

43. Drug Candidate Molecule

A drug candidate molecule or like terms is a test molecule which is being tested for its ability to function as a drug or a pharmacophore. This molecule may be considered as a lead molecule.

44. Efficacy

Efficacy or like terms is the capacity to produce a desired size of an effect under ideal or optimal conditions. It is these conditions that distinguish efficacy from the related concept of effectiveness, which relates to change under real-life conditions. Efficacy is the relationship between receptor occupancy and the ability to initiate a response at the molecular, cellular, tissue or system level.

45. Higher and Inhibit and Like Words

The terms higher, increases, elevates, or elevation or like terms or variants of these terms, refer to increases above basal levels, e.g., as compared a control. The terms low, lower, reduces, decreases or reduction or like terms or variation of these terms, refer to decreases below basal levels, e.g., as compared to a control. For example, basal levels are normal in vivo levels prior to, or in the absence of, or addition of a molecule such as an agonist or antagonist to a cell Inhibit or forms of inhibit or like terms refers to reducing or suppressing.

46. HepG2C3A Cell Line

The term “HepG2C3A” or like terms is a cell line which is a tumor cell line related to HepG2 cell line.

47. HepG2 Cell Line

HepG2 (ATCC No. HB-8065) is a human hepatocellular carcinoma cell line, and a perpetual cell line which was derived from the liver tissue of a 15 year old Caucasian American male with a well differentiated hepatocellular carcinoma. These cells are epithelial in morphology, have a model chromosome number of 55 and are not tumorigenic in nude mice. The cells secrete a variety of major plasma proteins; e.g., albumin, transferrin and the acute phase proteins fibrinogen, alpha 2-macroglobulin, alpha 1-antitrypsin, transferrin and plasminogen. The cells will respond to stimulation with human growth hormone.

HepG2 cells are a suitable in vitro model system for the study of polarized human hepatocytes. Another well-characterized polarized hepatocyte cell lines includes the rat hepatoma-derived hybrid cell line WIF-B. With the proper culture conditions, HepG2 cells display robust morphological and functional differentiation with a controlable formation of apical and basolateral cell surface domains that resemble the bile canalicular (BC) and sinusoidal domains, respectively, in vivo (see summary in http://www.ATCC.org).

48. JAK (Janus Kinase) Mediated Signaling

JAK mediated signaling refers to a signaling upstream or downstream of a molecule or substance which interacts with JAK. An opener for endogenous ATP-sensitive potassium (K_{ATP}) ion channel, such as pinacidil, can be an activator of JAK mediated signaling. JAKs and STATs (Signal transduction and transcpription proteins) are critical components of many cytokine receptor systems, regulating growth, survival, differentiation and pathogen resistance. An example is the IL-6 (or gp130) family of receptors, which co-regulate B cell differentiation, plasmacytogenesis and the acute phase reaction. Cytokine binding induces receptor dimerization, activating the associated JAKs, which phosphorylate themselves and the receptor. The phosphorylated sites on the receptor and Jaks serve as docking sites for the SH2-containing Stats, such as Stat3, and for SH2-containing proteins and adaptors that link the receptor to MAP kinase, PI3 Kinase/Akt and other cellular pathways.

Janus kinase mutations are major molecular events in human hematological malignancies. A unique somatic mutation in the Jak2 pseudokinase domain (V617F) occurs in >90% of polycythemia vera patients, and in a large proportion of essential thrombocythemia and idiopathic myelofibrosis patients. This mutation results in the pathologic activation Jak2 kinase, which leads to malignant transformation of hematopoietic progenitors. Several Jak3 pseudokinase domain mutations, present in some patients with acute megakaryoblastic leukemia, also render Jak3 constitutively active. Somatic acquired gain-of function mutations in Jak1 have been discovered in approximately 20% of adult T-cell acute lymphoblastic leukemia.

49. JAK Activator

A “JAK activator” is any molecule that functions to activate JAK.

50. JAK Inhibitor

A “JAK inhibitor” is any molecule that functions to inhibit JAK. Known JAK inhibitors include, but not limited to, AG490.

51. JAK Modulator

A “JAK Modulator” is any molecule that functions to modulate JAK, increase or decrease JAK activity. Known JAK modulators include, but not limited to, AG490.

52. In the Presence of the Molecule

“in the presence of the molecule” or like terms refers to the contact or exposure of the cultured cell with the molecule. The contact or exposure can be taken place before, or at the time, the stimulus is brought to contact with the cell.

53. Index

An index or like terms is a collection of data. For example, an index can be a list, table, file, or catalog that contains one or more modulation profiles. It is understood that an index can be produced from any combination of data. For example, a DMR profile can have a P-DMR, a N-DMR, and a RP-DMR. An index can be produced using the completed date of the profile, the P-DMR data, the N-DMR data, the RP-DMR data, or any point within these, or in combination of these or other data. The index is the collection of any such information. Typically, when comparing indexes, the indexes are of like data, i.e. P-DMR to P-DMR data.

i. Biosensor Index

A “biosensor index” or like terms is an index made up of a collection of biosensor data. A biosensor index can be a collection of biosensor profiles, such as primary profiles, or secondary profiles. The index can be comprised of any type of data. For example, an index of profiles could be comprised of just an N-DMR data point, it could be a P-DMR data point, or both or it could be an impedence data point. It could be all of the data points associated with the profile curve.

ii. DMR Index

A “DMR index” or like terms is a biosensor index made up of a collection of DMR data.

54. Kinetic Response of the Cells/Markers in the Absence and Presence of a Molecule

“kinetic response of the cells/markers in the absence and presence of a molecule” or like phrases refers to the entire assay or partial assay time series of cellular responses induced by a marker in the absence and presence of a molecule which can be directly used for examining the pharmacology or mode of action of the molecule, using, for example, pattern recognition analysis.

55. Known Molecule

A known molecule or like terms is a molecule with known pharmacological/biological/physiological/pathophysiological activity whose precise mode of action(s) may be known or unknown.

56. Known Modulator

A known modulator or like terms is a modulator where at least one of the targets is known with a known affinity. For example, a known modulator could be a PI3K inhibitor, a PKA inhibitor, a GPCR antagonist, a GPCR agonist, a RTK inhibitor, an epidermal growth factor receptor neutralizing antibody, or a phosphodiesterase inhibition, a PKC inhibitor or activator, etc.

57. Known Modulator Biosensor Index

A “known modulator biosensor index” or like terms is a modulator bio sensor index produced by data collected for a known modulator. For example, a known modulator biosensor index can be made up of a profile of the known modulator acting on the panel of cells, and the modulation profile of the known modulator against the panels of markers, each panel of markers for a cell in the panel of cells.

58. Known Modulator DMR Index

A “known modulator DMR index” or like terms is a modulator DMR index produced by data collected for a known modulator. For example, a known modulator DMR index can be made up of a profile of the known modulator acting on the panel of cells, and the modulation profile of the known modulator against the panels of markers, each panel of markers for a cell in the panel of cells.

59. Ligand

A ligand or like terms is a substance or a composition or a molecule that is able to bind to and form a complex with a biomolecule to serve a biological purpose. Actual irreversible covalent binding between a ligand and its target molecule is rare in biological systems. Ligand binding to receptors alters the chemical conformation, i.e., the three dimensional shape of the receptor protein. The conformational state of a receptor protein determines the functional state of the receptor. The tendency or strength of binding is called affinity. Ligands include substrates, blockers, inhibitors, activators, and neurotransmitters. Radioligands are radioisotope labeled ligands, while fluorescent ligands are fluorescently tagged ligands; both can be considered as ligands are often used as tracers for receptor biology and biochemistry studies. Ligand and modulator are used interchangeably.

60. Library

A library or like terms is a collection. The library can be a collection of anything disclosed herein. For example, it can be a collection, of indexes, an index library; it can be a collection of profiles, a profile library; or it can be a collection of DMR indexes, a DMR index library; Also, it can be a collection of molecule, a molecule library; it can be a collection of cells, a cell library; it can be a collection of markers, a marker library; a library can be for example, random or non-random, determined or undetermined. For example, disclosed are libraries of DMR indexes or biosensor indexes of known modulators.

61. Liver Cell

“Liver cells” or like terms refer to cells that are either derived from or obtained from liver tissue. Liver cells can include primary liver cells, transformed liver cells such as hepatocyte C3A, and immortalized liver cells such as F2N4 cells. In embodiments, the liver cells can include helper cells such as fibroblast cells NIH3T3. Examples of suitable helper cells include fibroblasts such as NIH 3T3 fibroblasts, murine 3T3-J2 fibroblasts or human fibroblast cells; human or rat hepatic stellate cells; and Kupffer cells.

62. Long Term Assay

“Long term assay” or like terms is used for studying the long-term impact of a given molecule on a living cell. A particular type of long term assay is a “long-term biosensor cellular assay.” In one embodiment, each type of cell is exposed to the molecule only for a long period of time (e.g., 8 hrs, 16 hrs, 24 hrs, 32 hrs, 48 hrs, and 72 hrs). This long-term assay is used to determine the impact of the molecule on the cell healthy state (e.g., viability, apoptosis, cell cycle regulation, cell adhesion regulation, proliferation). Also this long-term assay contains early cell signaling response (e.g., 30 min, 60 min, 120 min, 180 min after molecule stimulation), which can be used directly to study the molecule-induced cell signaling events or pathways.

In another embodiment, a long-term biosensor cellular assay in the presence of a marker is used to study the cross regulation of the long-term impacts on cell biology and physiology between the molecule and the marker. The marker(s) can be added before, at, and after the molecule. For example, when a marker (e.g., H₂O₂) triggers the apoptosis of at least one type of cells in the cell panel, one can use such long-term assays to determine whether the molecule is protective or not. The reverse is also true that such long-terms assays can be used to determine the protective or synergistic role of a marker against a molecule-induced cellular event (e.g., apoptosis, or necrosis).

63. Long-Term Biosensor Signal

A “long term biosensor signal” is a biosensor signal produced from a long term assay.

64. Long-Term DMR Signal

A long term DMR signal or like terms is an optical biosensor signal produced from a long term optical biosensor cellular assay.

65. Marker

A marker or like terms is a ligand which produces a signal in a biosensor cellular assay. The signal is, must also be, characteristic of at least one specific cell signaling pathway(s) and/or at least one specific cellular process(es) mediated through at least one specific target(s). The signal can be positive, or negative, or any combinations (e.g., oscillation).

66. Marker Panel

A “marker panel” or like terms is a panel which comprises at least two markers. The markers can be for different pathways, the same pathway, different targets, or even the same targets.

67. Marker Biosensor Index

A “marker biosensor index” or like terms is a biosensor index produced by data collected for a marker. For example, a marker biosensor index can be made up of a profile of the marker acting on the panel of cells, and the modulation profile of the marker against the panels of markers, each panel of markers for a cell in the panel of cells.

68. Marker DMR Index

A “marker biosensor index” or like terms is a biosensor DMR index produced by data collected for a marker. For example, a marker DMR index can be made up of a profile of the marker acting on the panel of cells, and the modulation profile of the marker against the panels of markers, each panel of markers for a cell in the panel of cells.

69. Material

Material is the tangible part of something (chemical, biochemical, biological, or mixed) that goes into the makeup of a physical object.

70. Medium

A medium is any mixture within which cells can be cultured. A growth medium is an object in which microorganisms or cells experience growth.

71. Mimic

As used herein, “mimic” or like terms refers to performing one or more of the functions of a reference object. For example, a molecule mimic performs one or more of the functions of a molecule.

72. Modulate

To modulate, or forms thereof, means either increasing, decreasing, or maintaining a cellular activity mediated through a cellular target. It is understood that wherever one of these words is used it is also disclosed that it could be 1%, 5%, 10%, 20%, 50%, 100%, 500%, or 1000% increased from a control, or it could be 1%, 5%, 10%, 20%, 50%, or 100% decreased from a control.

73. Modulator

A modulator or like terms is a ligand that controls the activity of a cellular target. It is a signal modulating molecule binding to a cellular target, such as a target protein.

74. Modulation Comparison

A “modulation comparison” or like terms is a result of normalizing a primary profile and a secondary profile.

75. Modulation Profile

A “modulation profile” or like terms is the comparison between a secondary profile of the marker in the presence of a molecule and the primary profile of the marker in the absence of any molecule. The comparison can be by, for example, subtracting the primary profile from secondary profile or subtracting the secondary profile from the primary profile or normalizing the secondary profile against the primary profile.

76. Modulator Biosensor Index

A “modulator biosensor index” or like terms is a biosensor index produced by data collected for a modulator. For example, a modulator biosensor index can be made up of a profile of the modulator acting on the panel of cells, and the modulation profile of the modulator against the panels of markers, each panel of markers for a cell in the panel of cells.

77. Modulator DMR Index

A “modulator DMR index” or like terms is a DMR index produced by data collected for a modulator. For example, a modulator DMR index can be made up of a profile of the modulator acting on the panel of cells, and the modulation profile of the modulator against the panels of markers, each panel of markers for a cell in the panel of cells.

78. Modulate the Biosensor Signal of a Marker

“Modulate the biosensor signal or like terms is to cause changes of the biosensor signal or profile of a cell in response to stimulation with a marker.

79. Modulate the DMR Signal

“Modulate the DMR signal or like terms is to cause changes of the DMR signal or profile of a cell in response to stimulation with a marker.

80. Molecule

As used herein, the terms “molecule” or like terms refers to a biological or biochemical or chemical entity that exists in the form of a chemical molecule or molecule with a definite molecular weight. A molecule or like terms is a chemical, biochemical or biological molecule, regardless of its size.

Many molecules are of the type referred to as organic molecules (molecules containing carbon atoms, among others, connected by covalent bonds), although some molecules do not contain carbon (including simple molecular gases such as molecular oxygen and more complex molecules such as some sulfur-based polymers). The general term “molecule” includes numerous descriptive classes or groups of molecules, such as proteins, nucleic acids, carbohydrates, steroids, organic pharmaceuticals, small molecule, receptors, antibodies, and lipids. When appropriate, one or more of these more descriptive terms (many of which, such as “protein,” themselves describe overlapping groups of molecules) will be used herein because of application of the method to a subgroup of molecules, without detracting from the intent to have such molecules be representative of both the general class “molecules” and the named subclass, such as proteins. Unless specifically indicated, the word “molecule” would include the specific molecule and salts thereof, such as pharmaceutically acceptable salts.

81. Molecule Mixture

A molecule mixture or like terms is a mixture containing at least two molecules. The two molecules can be, but not limited to, structurally different (i.e., enantiomers), or compositionally different (e.g., protein isoforms, glycoform, or an antibody with different poly(ethylene glycol) (PEG) modifications), or structurally and compositionally different (e.g., unpurified natural extracts, or unpurified synthetic compounds).

82. Molecule Biosensor Index

A “molecule biosensor index” or like terms is a biosensor index produced by data collected for a molecule. For example, a molecule biosensor index can be made up of a profile of the molecule acting on the panel of cells, and the modulation profile of the molecule against the panels of markers, each panel of markers for a cell in the panel of cells.

83. Molecule DMR index

A “molecule DMR index” or like terms is a DMR index produced by data collected for a molecule. For example, a molecule biosensor index can be made up of a profile of the molecule acting on the panel of cells, and the modulation profile of the molecule against the panels of markers, each panel of markers for a cell in the panel of cells.

84. Molecule Index

A “molecule index” or like terms is an index related to the molecule.

85. Molecule-Treated Cell

A molecule-treated cell or like terms is a cell that has been exposed to a molecule.

86. Molecule Modulation Index

A “molecule modulation index” or like terms is an index to display the ability of the molecule to modulate the biosensor output signals of the panels of markers acting on the panel of cells. The modulation index is generated by normalizing a specific biosensor output signal parameter of a response of a cell upon stimulation with a marker in the presence of a molecule against that in the absence of any molecule.

87. Molecule Pharmacology

Molecule pharmacology or the like terms refers to the systems cell biology or systems cell pharmacology or mode(s) of action of a molecule acting on a cell. The molecule pharmacology is often characterized by, but not limited, toxicity, ability to influence specific cellular process(es) (e.g., proliferation, differentiation, reactive oxygen species signaling), or ability to modulate a specific cellular target (e.g, K_{ATP} channel, PKA, PKC, PKG, JAK2, MAPK, MEK2, or actin).

88. Native Cell

A native cell is any cell that has not been genetically engineered. A native cell can be a primary cell, a immortalized cell, a transformed cell line, a stem cell, or a stem cell derived cell.

89. Normal K_{ATP} Pathway Cell Line

A normal K_{ATP} pathway cell line is a cell line in which the K_{ATP} pathway is not deregulated, and thus not constitutively activated. However, such cell line may still contain certain protein mutants that are not able to result in constitutive activation of the K_{ATP} pathway.

90. Normalizing

Normalizing or like terms means, adjusting data, or a profile, or a response, for example, to remove at least one common variable. For example, if two responses are generated, one for a marker acting a cell and one for a marker and molecule acting on the cell, normalizing would refer to the action of comparing the marker-induced response in the absence of the molecule and the response in the presence of the molecule, and removing the response due to the marker only, such that the normalized response would represent the response due to the modulation of the molecule against the marker. A modulation comparison is produced by normalizing a primary profile of the marker and a secondary profile of the marker in the presence of a molecule (modulation profile).

91. Non Viral Infection

The term “nonviral infection” or like terms refers to the state in which a cell has been infected with an organism which is not a virus, such as a bacteria or parasite. It means a state in which the cell has become contaminated with an organism other than a virus.

92. Optional

“Optional” or “optionally” or like terms means that the subsequently described event or circumstance can or cannot occur, and that the description includes instances where the event or circumstance occurs and instances where it does not. For example, the phrase “optionally the composition can comprise a combination” means that the composition may comprise a combination of different molecules or may not include a combination such that the description includes both the combination and the absence of the combination (i.e., individual members of the combination).

93. Or

The word “or” or like terms as used herein means any one member of a particular list and also includes any combination of members of that list.

94. Panel

A panel or like terms is a predetermined set of specimens (e.g., markers, or cells, or pathways). A panel can be produced from picking specimens from a library.

95. Panning

Panning or like terms refers to screening a cell or cells for the presence of one or more receptors or cellular targets.

96. Pathway

A pathway as used herein is a series of chemical reactions occurring within a cell. Within a pathway, one molecule or substance is modified which then leads to another molecule or substance being modified and so on. Often, enzymes such as kinases are involved in these modifications. Pathways can occur from the cell surface to the nucleus, as well as from organelle to organelle within a cell, or from cytosol to organelle or organelle to cytosol. The modification includes chemical (e.g., phosphorylation) or physical (e.g., translocation from one location to another) modifications.

97. Period of Time

A “period of time” refers to any period representing a passage of time. For example, 1 second, 1 minute, 1 hour, 1 day, and 1 week are all periods of time.

98. Profile

A profile or like terms refers to the data which is collected for a composition, such as a cell. A profile can be collected from a label free biosensor as described herein.

i. Primary Profile

A “primary profile” or like terms refers to a biosensor response or biosensor output signal or profile which is produced when a molecule contacts a cell. Typically, the primary profile is obtained after normalization of initial cellular response to the net-zero biosensor signal (i.e., baseline)

ii. Secondary Profile

A “secondary profile” or like terms is a biosensor response or biosensor output signal of cells in response to a marker in the presence of a molecule. A secondary profile can be used as an indicator of the ability of the molecule to modulate the marker-induced cellular response or biosensor response.

iii. Modulation Profile

A “modulation profile” or like terms is the comparison between a secondary profile of the marker in the presence of a molecule and the primary profile of the marker in the absence of any molecule. The comparison can be by, for example, subtracting the primary profile from secondary profile or subtracting the secondary profile from the primary profile or normalizing the secondary profile against the primary profile.

99. Positive Control

A “positive control” or like terms is a control that shows that the conditions for data collection can lead to data collection.

100. Post-Stimulation

Post-stimulation or like terms refers to a time after the stimulation of a cell with a molecule in a cellular assay.

101. Potential K_{ATP} inhibitor

A potential K_{ATP} inhibitor is any molecule in which the molecule is determined to be similar to a known K_{ATP} inhibitor as discussed herein. The known K_{ATP} inhibitors include, but not limited to, sulfonylureas. A known K_{ATP} inhibitor can be used as a referencing molecule for comparison.

102. Potential K_{ATP} Modulator

A “potential K_{ATP} modulator” is any molecule, compound or composition that functions similarly to a K_{ATP} modulator in an assay disclosed herein.

103. Potential Rho Kinase Inhibitor

A potential Rho kinase (ROCK) inhibitor is any molecule in which the molecule is determined to be similar to a known ROCK inhibitor as discussed herein. The known ROCK inhibitors include, but not limited to, Y27632, H-89, and H-8.

104. K_{ATP} Inhibitor and Known K_{ATP} Inhibitor

A K_{ATP} inhibitor is any molecule which has been determined to be an inhibitor of K_{ATP}. The known K_{ATP} inhibitors include, but not limited to, sulfonylureas. A known K_{ATP} inhibitor can be used as a referencing molecule for comparison

105. K_{ATP} Cell Line

A “K_{ATP} cell line” or like terms refers to type of cells that express at least one K_{ATP} channel. Non-limiting examples of K_{ATP} cell lines are HepG2 or HepG2C3A. It is understood that a mito-K_{ATP} or like terms refers to a K_{ATP} in a mitochondria.

106. K_{ATP} Inhibitor

A “K_{ATP} inhibitor” is any molecule, compound or composition that functions to inhibit a K_{ATP} channel from opening.

107. K_{ATP} Modulator

A “K_{ATP} modulator” is any molecule, compound or composition that functions to modulate a K_{ATP} channel opening or inhibiting it from opening.

108. Potassium Channel Opener (KCO)

A “potassium channel opener” is any molecule, compound or composition that functions to open a K_{ATP} channel.

109. Potentiate

Potentiate, potentiated or like terms refers to an increase of a specific parameter of a biosensor response of a marker in a cell caused by a molecule. By comparing the primary profile of a marker with the secondary profile of the same marker in the same cell in the presence of a molecule, one can calculate the modulation of the marker-induced biosensor response of the cells by the molecule. A positive modulation means the molecule to cause increase in the biosensor signal induced by the marker.

110. Profile

A profile or like terms refers to the data which is collected for a composition, such as a cell. A profile can be collected from a label free biosensor as described herein.

111. Pulse Stimulation Assay

A “pulse stimulation assay” or like terms can used, wherein the cell is only exposed to a molecule for a very short of time (e.g., seconds, or several minutes). This pulse stimulation assay can be used to study the kinetics of the molecule acting on the cells/targets, as well as its impact on the marker-induced biosensor signals. The pulse stimulation assay can be carried out by simply replacing the molecule solution with the cell assay buffer solution by liquid handling device at a given time right after the molecule addition.

112. Potency

Potency or like terms is a measure of molecule activity expressed in terms of the amount required to produce an effect of given intensity. For example, a highly potent drug evokes a larger response at low concentrations. The potency is proportional to affinity and efficacy. Affinity is the ability of the drug molecule to bind to a receptor.

113. Publications

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon.

114. Pulse Stimulation Assay

A “pulse stimulation assay” or like terms can used, wherein the cell is only exposed to a molecule for a very short of time (e.g., seconds, or several minutes). This pulse stimulation assay can be used to study the kinetics of the molecule acting on the cells/targets, as well as its impact on the marker-induced biosensor signals. The pulse stimulation assay can be carried out by simply replacing the molecule solution with the cell assay buffer solution by liquid handling device at a given time right after the molecule addition.

115. Ranges

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that the throughout the application, data is provided in a number of different formats, and that this data, represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

116. Receptor

A receptor or like terms is a protein molecule embedded in either the plasma membrane or cytoplasm of a cell, to which a mobile signaling (or “signal”) molecule may attach. A molecule which binds to a receptor is called a “ligand,” and may be a peptide (such as a neurotransmitter), a hormone, a pharmaceutical drug, or a toxin, and when such binding occurs, the receptor goes into a conformational change which ordinarily initiates a cellular response. However, some ligands merely block receptors without inducing any response (e.g. antagonists). Ligand-induced changes in receptors result in physiological changes which constitute the biological activity of the ligands.

117. Robust Biosensor Signal

A “robust biosensor signal” is a biosensor signal whose amplitude(s) is significantly (such as 3×, 10×, 20×, 100×, or 1000×) above either the noise level, or the negative control response. The negative control response is often the biosensor response of cells after addition of the assay buffer solution (i.e., the vehicle). The noise level is the biosensor signal of cells without further addition of any solution. It is worthy of noting that the cells are always covered with a solution before addition of any solution.

118. Robust DMR Signal

A “robust DMR signal” or like terms is a DMR form of a “robust biosensor signal.”

119. Rho-Mediated Signaling

Rho mediated signaling refers to any signaling upstream or downstream of a molecule or substance which interacts with Rho kinases. An opener for endogenous ATP-sensitive potassium (K_{ATP}) ion channel, such as pinacidil, can be an activator of Rho mediated signaling.

120. Rho Kinase Inhibitor

A Rho Kinase (ROCK) inhibitor is any molecule or substance which has been determined to inhibit Rho Kinase, such as Y-27632, ROCK kinase inhibitor III Rockout, Rho kinase inhibitor IV, H89, and H8.

121. ROCK Inhibitor Responsive Cell Line

A ROCK kinase inhibitor responsive cell line is any cell line in which inhibiting the basal activity of ROCKs by a known ROCK inhibitor leads to a detectable biosensor signal in the cell. For example, A549 is also a ROCK inhibitor responsive cell line. The unstimulated A549, due to the presence of activating K-RAS mutants, contains deregulated PI3K/Akt activity. ROCK is a downstream target of PI3K. Thus, inhibiting the basal activity of ROCK by a known ROCK inhibitor such as Y27632 or 1189 could lead to a robust DMR signal in A549 cells.

122. ROCK Inhibitor

A “ROCK inhibitor” is any molecule that functions to inhibit ROCK. Known ROCK inhibitors include, but not limited to, Y27632, H-89, and H-8.

123. ROCK Modulator

A “ROCK Modulator” is any molecule that functions to modulate ROCK, increase or decrease ROCK activity. Known ROCK modulators include, but not limited to, Y27632, H-89, and 11-8.

124. Response

A response or like terms is any reaction to any stimulation.

125. Sample

By sample or like terms is meant an animal, a plant, a fungus, etc.; a natural product, a natural product extract, etc.; a tissue or organ from an animal; a cell (either within a subject, taken directly from a subject, or a cell maintained in culture or from a cultured cell line); a cell lysate (or lysate fraction) or cell extract; or a solution containing one or more molecules derived from a cell or cellular material (e.g. a polypeptide or nucleic acid), which is assayed as described herein. A sample may also be any body fluid or excretion (for example, but not limited to, blood, urine, stool, saliva, tears, bile) that contains cells or cell components.

126. Serum Containing Medium

Serum containing medium or like words is any cell culture medium which contains serum (such as fetal bovine serum). Fetal bovine serum (or fetal calf serum) is the portion of plasma remaining after coagulation of blood, during which process the plasma protein fibrinogen is converted to fibrin and remains behind in the clot. Fetal Bovine serum comes from the blood drawn from the unborn bovine fetus via a closed system venipuncture at the abattoir. Fetal Bovine Serum (FBS) is the most widely used serum due to being low in antibodies and containing more growth factors, allowing for versatility in many different applications. FBS is used in the culturing of eukaryotic cells.

127. Serum Depleted Medium

A serum depleted medium is any cell culture medium that does not contain serum.

128. “Short Period of Time”

A “short period of time” or like terms is a time period that is typically between 1 and 30 minutes.

129. Short Term Assay

A “short term assay” or like terms is used for studying the short-term impact of a given molecule on a living cell. A particular type of short term assay is a “short-term biosensor cellular assay.” In one embodiment, each type of cell is exposed to the molecule only for a short period of time (e.g., 5 min, 10 min, 30 min, 45 min, 60 min, 90 min, 180 min, and 240 min). This short-term assay is often used for detecting early cell signaling response, which can be used directly to study the molecule-induced cell signaling events or pathways or to study the ability of the molecule to modulate a marker-induced cellular response.

130. Signaling

Signaling refers to the modification of one molecule or substance in a pathway leading to another modification of another molecule or substance within a pathway.

131. Signaling Pathway(s)

A “defined pathway” or like terms is a path of a cell from receiving a signal (e.g., an exogenous ligand) to a cellular response (e.g., increased expression of a cellular target). In some cases, receptor activation caused by ligand binding to a receptor is directly coupled to the cell's response to the ligand. For example, the KCO, pinacidil can activate a cell surface receptor that is part of an ion channel pinacidil binding to a K_{ATP} channel opens a potassium-selective ion channel that is part of the receptor. K_{ATP} activation allows negatively charged potassium ions to move into the cell which promotes various actions depending on the cell the channel resides in. However, for many cell surface receptors, ligand-receptor interactions are not directly linked to the cell's response. The activated receptor must first interact with other proteins inside the cell before the ultimate physiological effect of the ligand on the cell's behavior is produced. Often, the behavior of a chain of several interacting cell proteins is altered following receptor activation. The entire set of cell changes induced by receptor activation is called a signal transduction mechanism or pathway. The signaling pathway can be either relatively simple or quite complicated.

132. Similarity of Indexes

“Similarity of indexes” or like terms is a term to express the similarity between two indexes, or among at least three indices, one for a molecule, based on the patterns of indices, and/or a matrix of scores. The matrix of scores are strongly related to their counterparts, such as the signatures of the primary profiles of different molecules in corresponding cells, and the nature and percentages of the modulation profiles of different molecules against each marker. For example, higher scores are given to more-similar characters, and lower or negative scores for dissimilar characters. Because there are only three types of modulation, positive, negative and neutral, found in the molecule modulation index, the similarity matrices are relatively simple. For example, a simple matrix will assign identical modulation (e.g., a positive modulation) a score of +1 and non-identical modulation a score of −1.

Alternatively, different scores can be given for a type of modulation but with different scales. For example, a positive modulation of 10%, 20%, 30%, 40%, 50%, 60%, 100%, 200%, etc, can be given a score of +1, +2, +3, +4, +5, +6, +10, +20, correspondingly. Conversely, for negative modulation, similar but in opposite score can be given.

133. Stable

When used with respect to pharmaceutical compositions, the term “stable” or like terms is generally understood in the art as meaning less than a certain amount, usually 10%, loss of the active ingredient under specified storage conditions for a stated period of time. The time required for a composition to be considered stable is relative to the use of each product and is dictated by the commercial practicalities of producing the product, holding it for quality control and inspection, shipping it to a wholesaler or direct to a customer where it is held again in storage before its eventual use. Including a safety factor of a few months time, the minimum product life for pharmaceuticals is usually one year, and preferably more than 18 months. As used herein, the term “stable” references these market realities and the ability to store and transport the product at readily attainable environmental conditions such as refrigerated conditions, 2° C. to 8° C.

134. Substance

A substance or like terms is any physical object. A material is a substance. Molecules, ligands, markers, cells, proteins, and DNA can be considered substances. A machine or an article would be considered to be made of substances, rather than considered a substance themselves.

135. Subject

As used throughout, by a subject or like terms is meant an individual. Thus, the “subject” can include, for example, domesticated animals, such as cats, dogs, etc., livestock (e.g., cattle, horses, pigs, sheep, goats, etc.), laboratory animals (e.g., mouse, rabbit, rat, guinea pig, etc.) and mammals, non-human mammals, primates, non-human primates, rodents, birds, reptiles, amphibians, fish, and any other animal. In one aspect, the subject is a mammal such as a primate or a human. The subject can be a non-human.

136. Suspension Cells

“Suspension cells” refers to a cell or a cell line that is preferably cultured in a medium wherein the cells do not attach or adhere to the surface of a substrate during the culture. However, suspension cells can, in general, be brought to contact with the biosensor surface, by either chemical (e.g., covalent attachment, or antibody-cell surface receptor interactions), or physical means (e.g., settlement down, due to the gravity force, the bottom of a well wherein a biosensor is embedded). Thus, suspension cells can also be used for biosensor cellular assays.

137. Test Molecule

A test molecule or like terms is a molecule which is used in a method to gain some information about the test molecule. A test molecule can be an unknown or a known molecule.

138. Treating

Treating or treatment or like terms can be used in at least two ways. First, treating or treatment or like terms can refer to administration or action taken towards a subject. Second, treating or treatment or like terms can refer to mixing any two things together, such as any two or more substances together, such as a molecule and a cell. This mixing will bring the at least two substances together such that a contact between them can take place.

When treating or treatment or like terms is used in the context of a subject with a disease, it does not imply a cure or even a reduction of a symptom for example. When the term therapeutic or like terms is used in conjunction with treating or treatment or like terms, it means that the symptoms of the underlying disease are reduced, and/or that one or more of the underlying cellular, physiological, or biochemical causes or mechanisms causing the symptoms are reduced. It is understood that reduced, as used in this context, means relative to the state of the disease, including the molecular state of the disease, not just the physiological state of the disease.

139. Trigger

A trigger or like terms refers to the act of setting off or initiating an event, such as a response.

140. Unknown Molecule

An unknown molecule or like terms is a molecule with unknown biological/pharmacological/physiological/pathophysiological activity. An 141. Values

Specific and preferred values disclosed for components, ingredients, additives, cell types, markers, and like aspects, and ranges thereof, are for illustration only; they do not exclude other defined values or other values within defined ranges. The compositions, apparatus, and methods of the disclosure include those having any value or any combination of the values, specific values, more specific values, and preferred values described herein.

Thus, the disclosed methods, compositions, articles, and machines, can be combined in a manner to comprise, consist of, or consist essentially of, the various components, steps, molecules, and composition, and the like, discussed herein. They can be used, for example, in methods for characterizing a molecule including a ligand as defined herein; a method of producing an index as defined herein; or a method of drug discovery as defined herein.

142. Viral Infection

The term “viral infection” or like terms refers to the state in which a cell has been infected with a virus. It means a state in which the cell has become contaminated with a virus.

### D. Examples

### 1. Experimental procedures (For Examples 1-5)

i. Reagents

All compounds were purchased from Sigma-Aldrich Inc., except the kinase inhibitor library and ion channel modulator library, Latrunculin A, which were purchased from BIOMOL International, L.P. (Plymouth Meeting, PA). Cell culture reagents were all purchased from GIBCO cell culture products.

ii. Cell Culture

All cell lines were purchased from ATCC and maintained according to ATCC's instructions. Cells were subcultured 1-2 times per week according to ATCC's instruction. Cell passage less than 15 was used for all experiments.

iii. RT-PCR

Total RNA of HepG2C3A cells were extracted from one T-75 flask with a confluent monolayer of cells (15-30 million cells) by using RNeasy Kit (Cat#75144) from Qiagen Inc., possible DNA contamination in the total RNA extraction was digested by using RNase-free Dnase Set (Cat#79254, Qiagen Inc.). The primer sequences used for RT-PCR were from Am. J. Respir. Cell Mol. Biol. (2002) 26:135-143 and FASEB J. (1999)13:1833-1838. All primers were synthesized by Sigma-Aldrich Inc. RT-PCR was performed using One-Step RT-PCR kit (Cat#210212) from Qiagen Inc. The PCR conditions were as follows: 50° C. for 30 minutes, 95° C. for 15 minutes, followed by 60 cycles of 1 minute at 94° C., 1.5 minute at 57° C. and 2 minute at 72° C., with a final extension of 10 minutes at 72° C.

iv. RNAi Knock Down

All siRNAs were selected from the pre-designed siRNA database from Sigma-Aldrich Inc. based on the ranking order for predicted knock-down efficiency. The siRNA IDs are SASI_Hs01_{—}00092347, SASI_Hs01_{—}00092348 and SASI_Hs01_{—}00092349 for SUR1(Refseq ID: NM_{—}000352); SASI_Hs01_{—}00061301, SASI_Hs01_{—}00061302 and SASI_Hs01_{—}00061303 for SUR2(Refseq ID: NM_{—}005691); SASI_Hs01_{—}00113357, SASI_Hs01_{—}00113358 and SASI_Hs01_{—}00113359 for Kir6.1 (Refseq ID: NM004982); SASI_Hs01_{—}00220256, SASI_Hs01_{—}00220257 and SASI_Hs01_{—}00220258 for Kir6.2 (Refseq ID: NM000525). SASI_Hs01_{—}00065573, SASI_Hs01_{—}00065571, SASI_Hs01_{—}00065570 for ROCK1 (RefseqID: NM_{—}005406). SASI_Hs01_{—}00204253, SASI_Hs01_{—}00204252, SASI_Hs01_{—}00204251 for ROCK2 (RefseqID: NM_{—}004850). SASI_Hs01_{—}00174614, SASI_Hs01_{—}00174613 for JAK1 (ReqID: NM_{—}002227). SASI_Hs02_{—}00338675, SASI_Hs01_{—}00041547 for JAK2 (ReqID: NM_{—}004972). SASI_Hs01_{—}00118128, SASI_Hs02_{—}00302103 for JAK3 (ReqID: NM_{—}000215).

Transfection of siRNAs was performed using N-TER Nanoparticle siRNA Transfection System (Cat#N2913) from Sigma-Aldrich Inc. following the manufacturer's instructions. Briefly, 5000 cells were plated in each well of Epic 384-well plates. Cells were transfected with 50 nM siRNA the next day and incubated in siRNA containing medium for 24 hrs before replaced with fresh cell culture medium. Epic cell assay was performed 48 hours after transfection.

For western blot experiments, C3A cells were plated in 6-well tissue culture treated plate with 3×10⁵/well. Cells were transfected with ROCK1 or ROCK2 siRNA (Rank1) at 50 nM final concentration 20 hours after plating. The transfection reagent containing media were removed and replaced with fresh media 24 hours after transfection. Cells were lysed 48 hours after transfection for western blot.

v. Immunoprecipitation and Western blot

For ROCK1 and ROCK2 Western blot, 120 μl cell lysate of each sample were mixed with 40 μl 4×SDS sample buffer then boiled at 100° C. for 5 minutes. Proteins were separated on 10% SDS gel, 15 μl of each sample was loaded to the gel. Membrane was blotted with either rabbit anti-ROCK1 (sc-5560), or rabbit anti-ROCK2 (sc-5561), or goat anti-Actin (sc-1616) (1:500 dilution) for 1 hr, then with 2nd HRP conjugated Goat anti-rabbit or Horse anti-goat antibody (1:2000 dilution) for 15 minutes.

For Kir6.2, 100 million C3A cells were lysed in 1% NP40 lysis buffer, immunoprecipitated with goat anti-Kir6.2 (sc-11228, G16) conjugated with Protein A sepharose (Sigma, P3391). Proteins were separated on 10% SDS gel, 30 μl of whole cell lysate or mitochondria lysate was loaded to the gel. Membrane was blotted with goat anti-Kir6.2 (sc-11228, 1:200) for 1 hr, then with 2nd HRP conjugated Goat anti-rabbit or Horse anti-goat antibody (1:2000 dilution) for 30 minutes. C3A mitochondria was isolated from 100 million C3A cells using mitochondria isolation kit for cultured cells from Invitrogen (Cat#KHM3031).

vi. Human Hepatocytes

Human primary hepatocytes were purchased from XenoTech (H1500.H15A+ Lot No. 770). Cells were thawed and purified using Xenotech Hepatocyte isolation kit (Cat#: K2000) according to the manufacturer's instructions. Cells (50,000/well) were plated in collagen I coated 96-well plate (BD Bioscience, Cat#354407) using Galactose-free MFE Plating Medium (Corning Inc.) containing 10% FBS on Day1. The medium was changed to MFE Maintenance Medium containing 10% FBS with 0.25 mg/ml Matrigel (BD Bioscience, Cat#356234) on Day 2. Cells were incubated at 37° C. with 5% CO2 from Day 1 to Day 8. From Day 5, cells were treated with 10 μM rifampin (Cat#R3501, Sigma-Aldrich Inc.) for CYP3A4 induction, or 50 μM Omeprazole (Cat#0104, Sigma-A1drich Inc.) for CYP1A2 induction, or equal volume of DMSO for 72 hours. On Day 8, CYP3A4 and CYP1A2 assays were performed using P450-Glo™ CYP3A4 Assay kit or P450-Glo™ CYP1A2 Assay kit (Cat#V8902 and V8772, Promega) or. Cell number was normalized using CytoTox 96® Non-Radioactive Cytotoxicity Assay (Cat#G1780, Promega).

vii. PCR-Array

Human hepatocytes were cultured as described above. On day 5, cells were harvested and total RNA were extracted using Qiagen RNeasy Mini kit (Cat#74104) with on column DNase digestion (Cat#79254). RNA concentration of each sample was quantified with Quant-iT™ RiboGreen® RNA Assay Kit (Invitrogen, Cat#R11490) and stored at −80° C. until PCR-array experiments. Array plates (Human Cancer Drug Resistance & Metabolism PCR Array, Cat#PAHS-004, SABioscience, Frederick, Md.) were prepared following SABioscience manual (Part#1022A). 1 vtg total RNA was used per 96-well array plate, each total RNA sample was tested in duplicate. The PCR-Array was performed on an ABI-7900HT with 96-well standard block using software SDS2.3. PCR conditions were set up as suggested in the user manual (Part#1022A). Data was analyzed using SABioscience online analysis tool.

vIii. Optical Biosensor System and Cell Assays

Epic® wavelength interrogation system (Corning Inc., Corning, N.Y.) was used for whole cell sensing. This system consists of a temperature-control unit, an optical detection unit, and an on-board liquid handling unit with robotics. The detection unit is centered on integrated fiber optics, and enables kinetic measures of cellular responses with a time interval of ˜15sec. The compound solutions were introduced by using the on-board liquid handling unit (i.e., pippetting).

The RWG biosensor is capable of detecting minute changes in local index of refraction near the sensor surface. Since the local index of refraction within a cell is a function of density and its distribution of biomass (e.g., proteins, molecular complexes), the biosensor exploits its evanescent wave to non-invasively detect ligand-induced dynamic mass redistribution in native cells. The evanescent wave extends into the cells and exponentially decays over distance, leading to a characteristic sensing volume of ˜150 nm, implying that any optical response mediated through the receptor activation only represents an average over the portion of the cell that the evanescent wave is sampling. The aggregation of many cellular events downstream the receptor activation determines the kinetics and amplitudes of a ligand-induced DMR.

For biosensor cellular assays, compound solutions were made by diluting the stored concentrated solutions with the HBSS (1× Hanks balanced salt solution, plus 20 mM Hepes, pH 7.1), and transferred into a 384well polypropylene compound storage plate to prepare a compound source plate. Two compound source plates were made separately when a two-step assay was performed. In parallel, the cells were washed twice with the HBSS and maintained in 30 μl of the HBSS to prepare a cell assay plate. Both the cell assay plate and the compound source plate(s) were then incubated in the hotel of the reader system. After incubation the baseline wavelengths of all biosensors in the cell assay microplate were recorded and normalized to zero. Afterwards, a 2 to 10 min continuous recording was carried out to establish a baseline, and to ensure that the cells reached a steady state. Cellular responses were then triggered by transferring 10 μl of the compound solutions into the cell assay plate using the on-board liquid handler.

All studies were carried out under controlled temperature (28° C.). At least two independent sets of experiments, each with at least three replicates, were performed. The assay coefficient of variation was found to be <10%.

### 2. Example 1

### The Presence of Mitochondria K_{ATP} Channels in Liver Cells

K_{ATP} channels serve as molecular sensors linking the cellular metabolic level to cell membrane excitability. The K_{ATP} channels are activated by interaction with intracellular MgADP and inhibited by high level of ATP. K_{ATP} channels have been found in cell plasma membrane, mitochondria inner membrane and nuclear envelope. To confirm the expression of K_{ATP} channel and to determine the specific K_{ATP} channel subunits in liver cell line HepG2C3A, RT-PCR was performed using primers specific for Kir6.1, Kir6.2, SUR1, SUR2A and SUR2B with isolated total RNA from HepG2C3A cells. As shown in FIG. 1, Kir6.1, Kir6.2, SUR2A and SUR2B were expressed in HepG2C3A cells, but not SUR1 subunit.

Whole cell patch clamp recording failed to detect any K⁺ selective current in HepG2C3A cells, indicating the K_{ATP} channels may not present in the cell plasma membrane. Mitochondria K_{ATP} channels have been reported in rat liver cells. Isolation of mitochondria from HepG2C3A cells followed by western blot indicated the presence of Kir6.2 in whole cell lysate and mitochondria lysate (FIG. 2).

### 3. Example 2

### Label-Free Cellular Assays Detect K_{ATP} Channels in Liver Cells

Label-free RWG biosensor cellular assays measure the mass redistribution induced by a compound in a given cell population. The signal obtained could be the sum of multiple cellular signaling events. However, K_{ATP} channel is an inward rectifier K⁺ channel, which can be activated by intracellular MgADP and specific KCOs at physiological conditions. The availability of channel composition specific KCOs and the sensitivity of label-free RWG biosensors make it possible to directly monitor the activation of K_{ATP} channel and subsequent cellular signaling events.

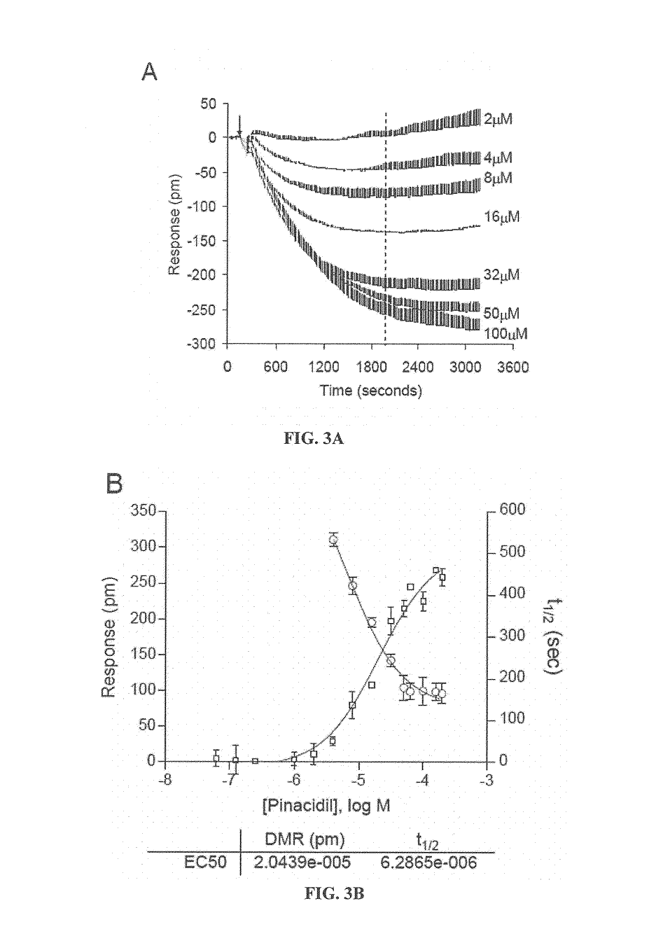

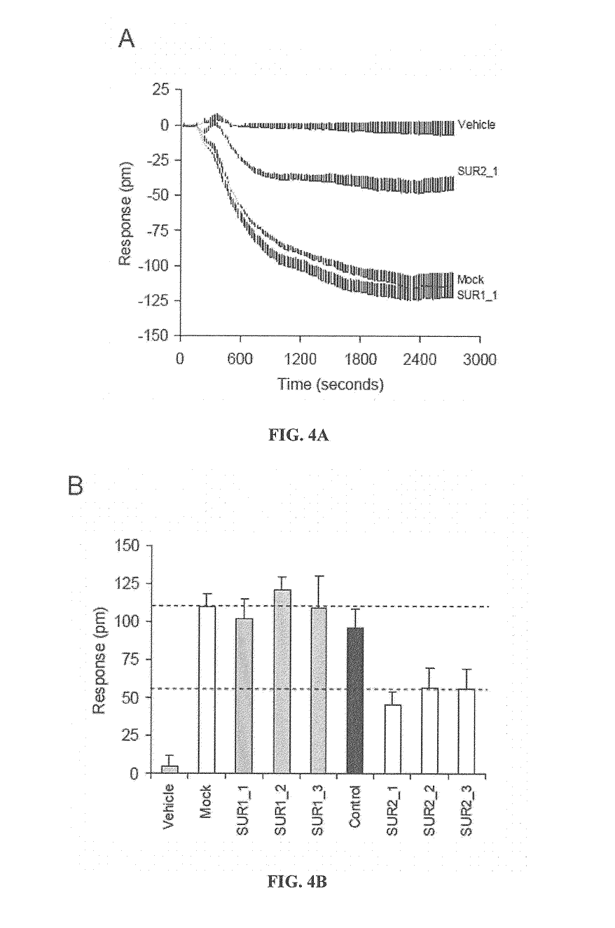

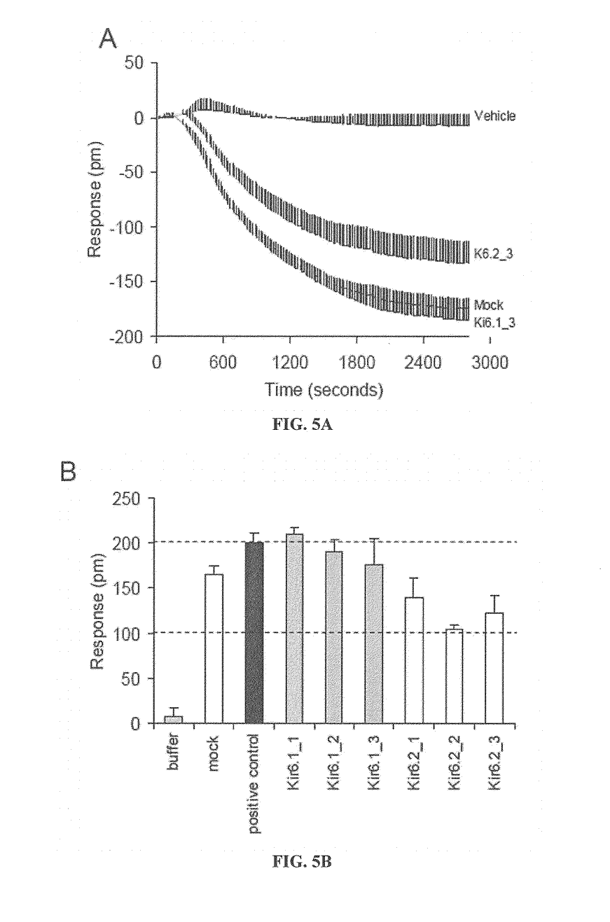

To demonstrate the feasibility and specificity of the label-free mito-K_{ATP} channel assay in liver cells, we first measured the dose-dependent responses of HepG2C3A cells induced by pinacidil (FIG. 3A), a Kir6.2/SUR2 specific KCO. FIG. 3B shows that both the amplitudes and kinetics of pinacidil induced DMR signal are concentration dependent. Because the mito-K_{ATP} channels activated by pinacidil are endogenously expressed, we speculated that knock down of any specific K_{ATP} channel subunit can result in the reduction of pinacidil induced DMR signal. As shown in FIG. 4, HepG2C3A cells transfected with SUR1 specific siRNAs had no impact on pinacidil induced DMR signal, while transfection with SUR2 specific siRNAs led to the significant reduction of pinacidil induced DMR signals. Similarly, FIG. 5 shows Kir6.1 specific siRNAs had no impact on pinacidil induced DMR signal, while cells transfected with Kir6.2 specific siRNAs had significantly reduced DMR signal compared to the controls.

K_{ATP} channels can be blocked by common sulfonylurea drugs, such as tolazamide, tobutamide, glipizide, etc. FIG. 6 shows that the pinacidil induced DMR signal in HepG2C3A cells can be dose-dependently inhibited by a panel of these sulfonylureas. Notably, a non-sulfonylurea blocker U-37883A, which has been reported to selectively inhibit Kir6.1 containing K_{ATP} channels had no effect on the pinacidil induced DMR signal. Together, these experiments demonstrate the label-free cellular assays can detect the activation of mito-K_{ATP} channels in liver cells and molecular composition of the responsible mito-K_{ATP} channels are probably Kir6.2 and SUR2.

### 4. Example 3

### The mito-K_{ATP} Signaling in Liver Cells is Linked to ROCK Activity

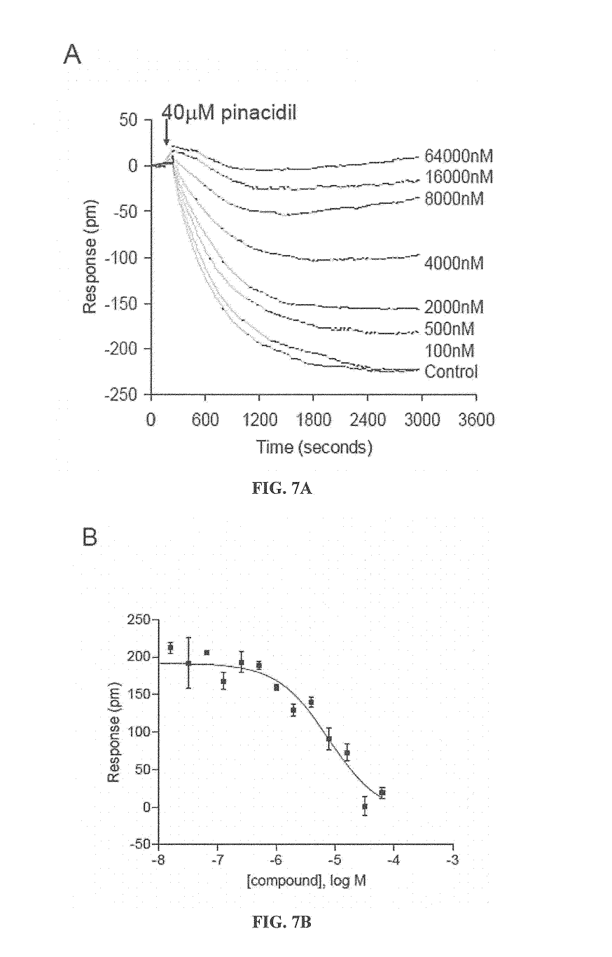

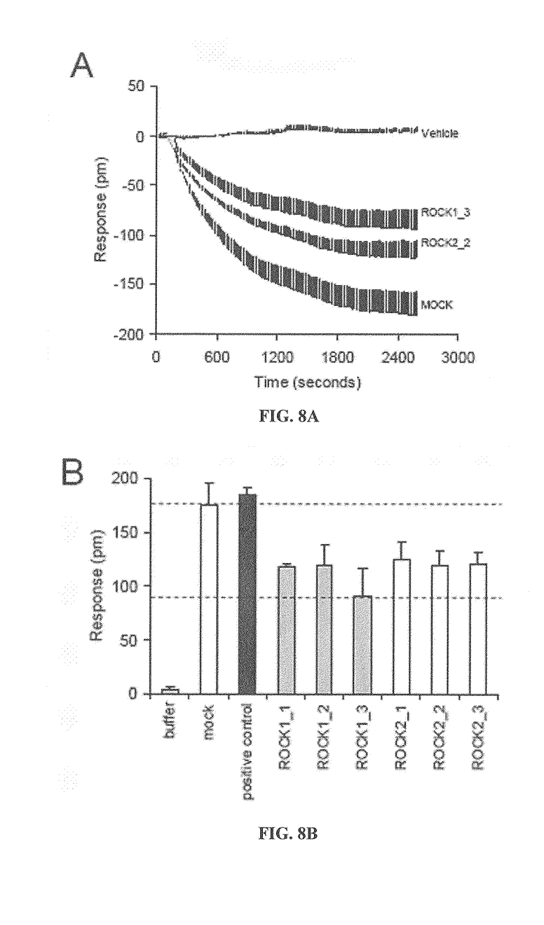

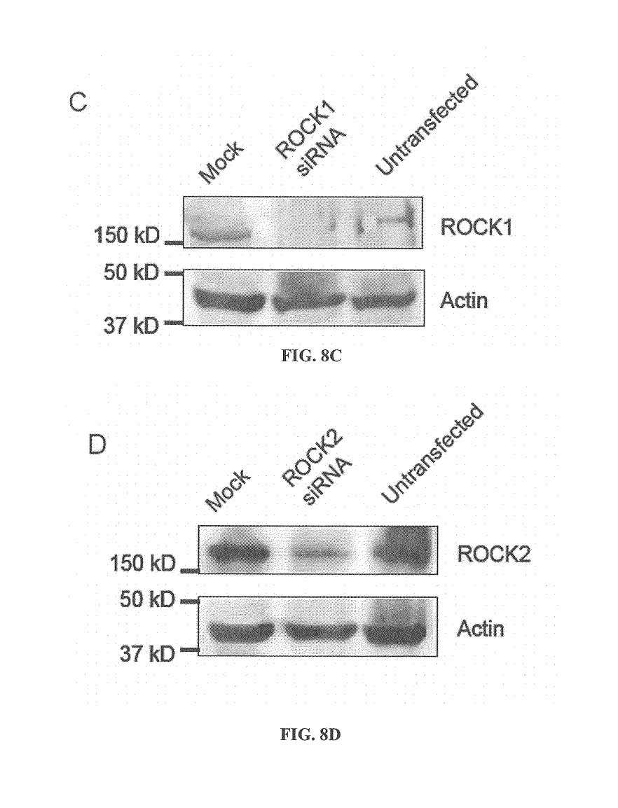

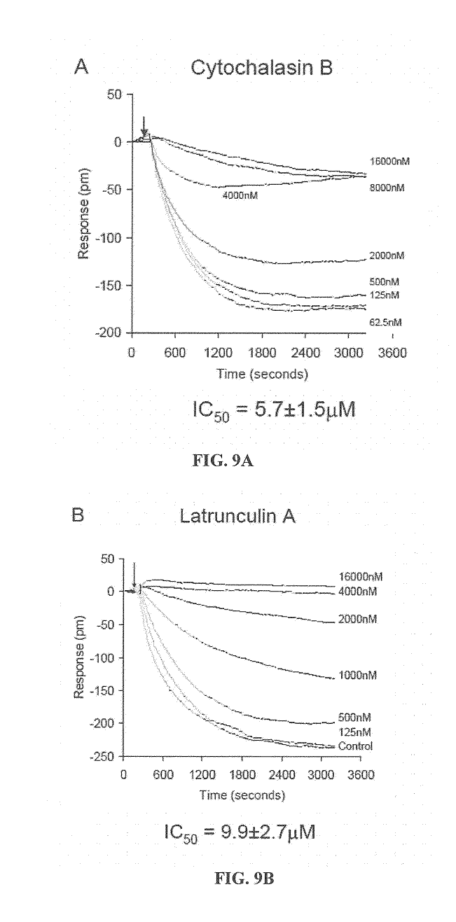

Rho kinases (ROCK1 and ROCK2) play important roles in the small GTPase rhoA initiated signaling pathways. Rho kinases were known involved in a variety of cellular functions including cytoskeleton organization, cell proliferation and apoptosis. As shown in FIG. 7, pre-incubation with ROCK inhibitor Y-27632 reduced the pinacidil induced DMR signal dose-dependently. Transfection of either ROCK1 or ROCK2 specific siRNAs significantly reduced the pinacidil induced DMR signals (FIGS. 8A and 8B). Western blots using ROCK1 and ROCK2 specific antibodies confirmed that the knock down of ROCK1 and ROCK2 protein levels in HepG2C3A cells (FIGS. 8C and 8D). Pre-incubation with two different actin filament disruption reagents either cytochalasin B or latrunculin A can also dose-dependently reduce the pinacidil induced DMR signals in HepG2C3A cells. These results indicate that the mito-K_{ATP} channel initiated signaling in liver cells is linked to ROCK activity.

### 5. Example 4

### The mito-K_{ATP} Signaling in Liver Cells is Linked to JAK Activity

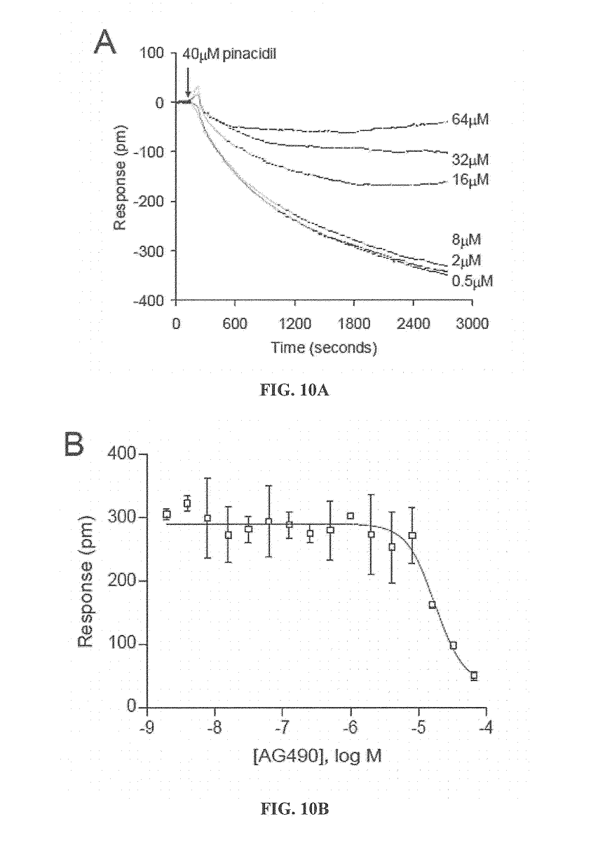

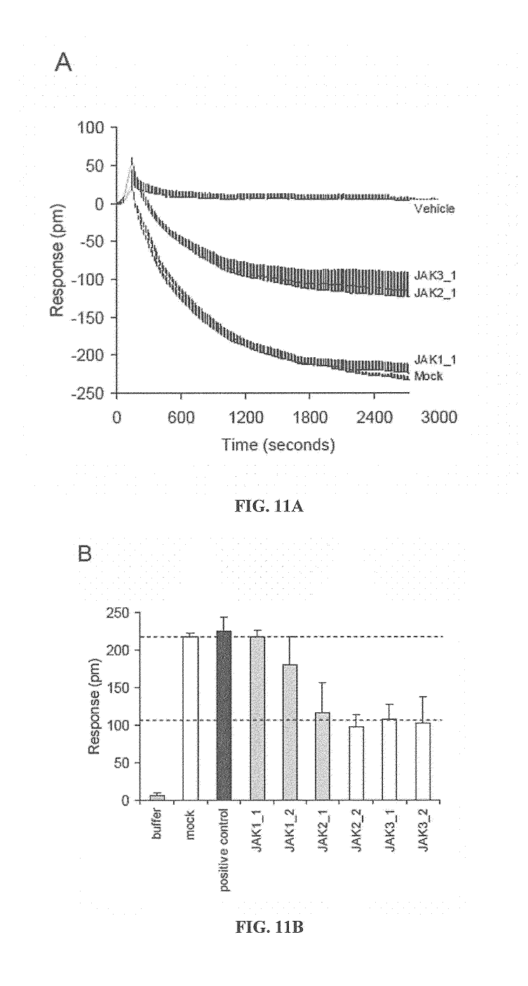

Janus kinases (JAK1, 2, 3) are protein tyrosine kinases involved in cytokine mediated cellular signaling; they are crucial for a variety of cellular functions including cellular survival, proliferation, differentiation and apoptosis. FIG. 10 shows that pre-incubation with JAK inhibitor AG490 dose-dependently reduced the pinacidil induced DMR signal in HepG2C3A cells. As shown in FIG. 11, transfection with JAK1 specific siRNAs had no impact on pinacidil induced DMR signal, while JAK2 or JAK3 specific siRNAs significantly attenuated the pinacidil induced DMR signals. These results indicate that activation of mito-K_{ATP} channel signaling is linked to JAK activity, particularly JAK2 and JAK3.

### 6. Example 5

### The mito-K_{ATP} Modulators Suppress the Rifampin Induction of CYP3A4 Activity

Rifampin is a semisynthetic antibiotic derived from a form of rifamycin that interferes with the synthesis of RNA and is used to treat bacterial and viral diseases. Rifampicin is typically used to treat Mycobacterium infections, including tuberculosis and leprosy; and also has a role in the treatment of methicillin-resistant Staphylococcus aureus (MRSA) in combination with fusidic acid. It is used in prophylactic therapy against Neisseria meningitidis (meningococcal) infection.

Rifampicin inhibits DNA-dependent RNA polymerase in bacterial cells by binding its beta-subunit, thus preventing transcription of messenger RNA (mRNA) and subsequent translation to proteins. Its lipophilic nature makes it a good candidate to treat the meningitis form of tuberculosis, which requires distribution to the central nervous system and penetration through the blood-brain barrier.

However, rifampin exhibits adverse effects that are chiefly related to the drug's hepatotoxicity, and patients receiving rifampicin often undergo liver function tests including aspartate aminotransferase (AST). Rifampicin is a potent inducer of hepatic cytochrome P450 enzymes (such as CYP2D6 and CYP3A4) and will increase the metabolism of many drugs that are cleared by the liver through this enzyme system. This results in numerous drug interactions such as reduced efficacy of hormonal contraception. For example, rifampin can enhance the metabolism of endogenous substrates including adrenal hormones, thyroid hormones, and vitamin D.

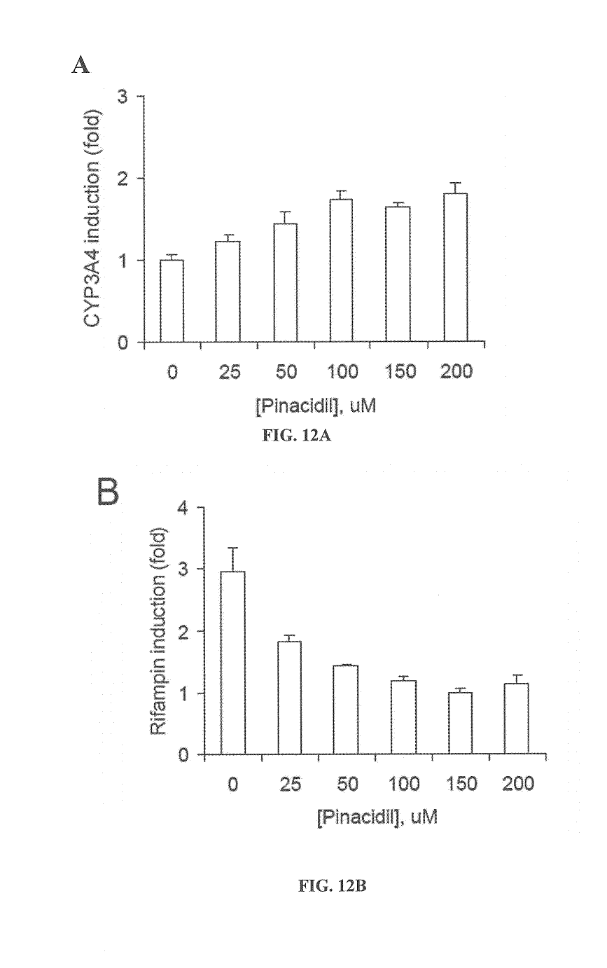

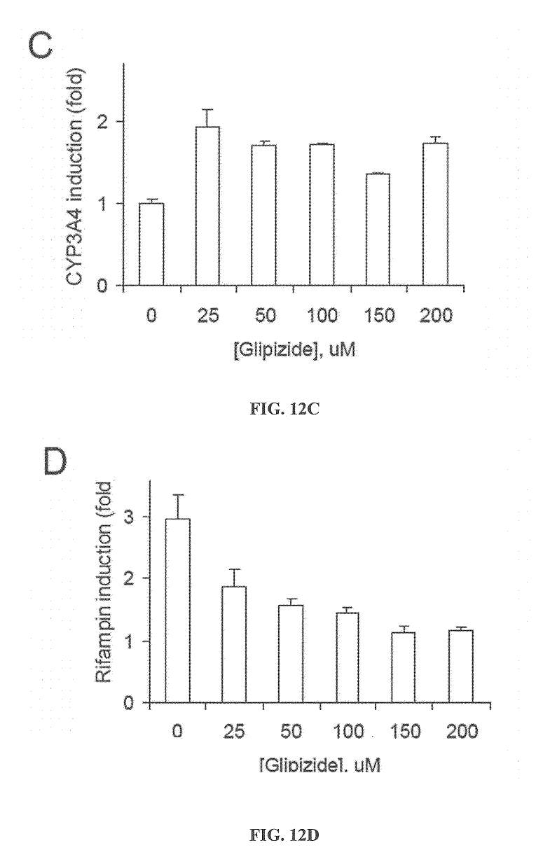

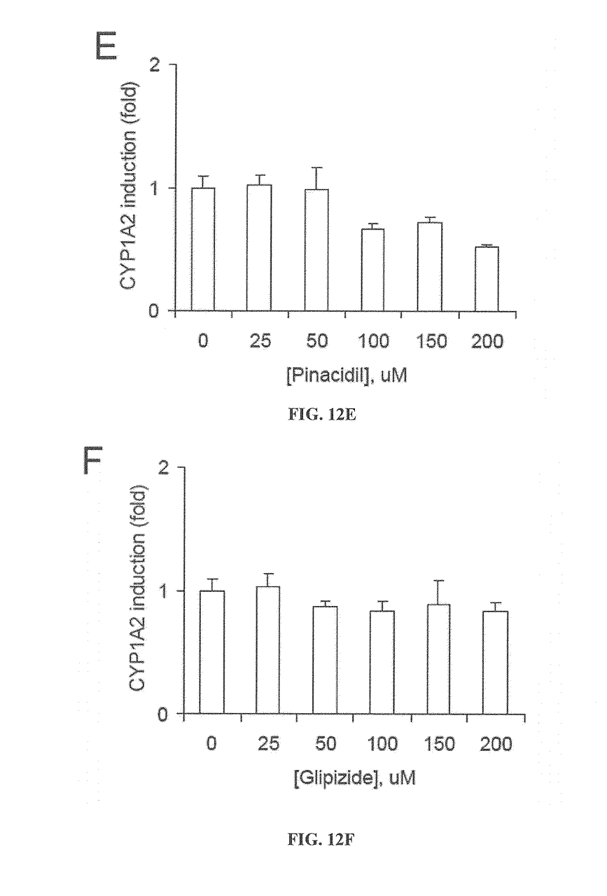

Using human primary hepatocytes cultured under collagen I-Matrigel sandwich conditions, the impacts of mito-K_{ATP} modulators as well as rifampin on CYP enzymatic activity were studied. As shown in FIG. 12A, pinacidil dose-dependently caused induction of CYP3A4 with a maximal induction of ˜2 fold. As expected, rifampin led to 3 fold induction of CYP3A4. However, pinacidil also dose-dependently suppressed the rifampin induction (FIG. 12B). Similar observations were observed for the mito-K_{ATP} blocker glipizide (FIG. 12C and FIG. 12D). On the other hand, both pinacidil and glipizide had little impact on the CYP1A2 activity. Taken together, these data indicates that mito-K_{ATP} modulators can suppress the CYP3A4 enzyme induction activity of the liver toxin rifampin, indicating that mito-K_{ATP} ion channels can be protective against liver toxin-induced damage.

### E. References

1. Fang, Y., Ferrie, A. M., Fontaine, N. H., Mauro, J., and Balakrishnan, J. (2006) Biophys. J. 91, 1925-1940.
2. Fang, Y., Ferrie, A. M., Fontaine, N. H., and Yuen, P. K. (2005) Anal. Chem. 77: 5720-5725.
3. Fang, Y. (2006) Assays and Drug development Technologies. 4: 583-595.
4. WO2006108183 A2 Fang, Y., Ferrie, A. M., Fontaine, N. M., Yuen, P. K. and Lahiri, J. “Optical biosensors and cells”

We claim:

1. A method of determining the on-target pharmacology of a molecule comprising the steps:
a. collecting biosensor responses from a panel of assay formats;
b. analyzing the biosensor responses; and
c. determining the on-target pharmacology of the molecule.

2. The method of claim 1, wherein the biosensor response is a label-free biosensor response.

3. The method of claim 1, wherein the panel consists of two to ten assay formats.

4. The method of claim 1, wherein the assay formats are selected from a sustained agonism stimulation assay, an antagonism assay, a sequential stimulation assay, a reverse sequential stimulation assay, a co-stimulation assay, modulation assay, and a modulation profiling assay.

5. The method of claim 1, wherein the assay formats are selected from a sustained agonism stimulation assay, a sequential antagonism stimulation assay, a reverse sequential stimulation assay, a co-stimulation with a pathway modulator, and modulation of a panel of markers for distinct pathways.

6. The method of claim 1, wherein one or more of the assays collects data from a predetermined time domain.

7. The method of claim 6, wherein there are 3-20, 3-15, 3-10, 3-7 or 3-5 time domain responses.

8. The method of claim 6, wherein the time domain responses are taken 0-3 minutes, 3-6 minutes, 6-10 minutes, 10-20 minutes, 20-50 minutes and 50-120 minutes post-stimulation.

9. The method of claim 6, wherein the time domain responses covers different waves of cell signaling.

10. The method of claim 6, wherein the time domain responses are taken 3, 5, 9, 15 and 50 min post-stimulation.

11. The method of claim 6, wherein analyzing the biosensor response comprises, numerically describing DMR signals.

12. The method of claim 11, further comprising ordering the numerically described DMR signals into a number matrix.

13. The method of claim 12, wherein the number matrix is produced by performing a clustering algorithm analysis.

14. The method of claim 13, wherein the clustering algorithm analysis is one or two-dimensional.

15. The method of claim 13, wherein the clustering algorithm is Hierarchical, K-means or Markov clustering algorithm.

16. The method of claim 13, wherein the clustering algorithm is Hierarchical.

17. The method of claim 13, wherein the Hierarchical links groups using pairwise maximum linkage.

18. The method of claim 13, wherein the clustering algorithm uses Euclidean distance for its metrics.

19. The method of claim 13, wherein the clusters are viewed as a heat map.

20. A method of repositioning a test molecule comprising the steps:
a. collecting biosensor responses of the test molecule from a panel of assay formats;
b. analyzing the biosensor responses of the test molecule;
c. determining the on-target pharmacology of the test molecule;
d. clustering the drug molecule with existing drug molecules acting on the same target to identify the closest match in the on-target pharmacology of drug molecules; and
e. repositioning the test molecule for the indication of the closest matched drug molecules.
